(19) United States
(12) Patent Application Publication
(10) Pub. No.: US 2024/0313887 A1
(43) Pub. Date: Sep. 19, 2024

(54) RATELESS POLAR CODES

(71) Applicant: QUALCOMM Incorporated, San Diego, CA (US)

(72) Inventors: Peer Berger, Hod Hasharon (IL); Shay Landis, Hod Hasharon (IL); Gideon Shlomo Kutz, Ramat Hasharon (IL)

(21) Appl. No.: 18/183,835

(22) Filed: Mar. 14, 2023

(51) Int. Cl. H04L 1/00

(52) U.S. Cl. CPC H04L 1/0057

(57) ABSTRACT

Methods, systems, and devices for wireless communication are described. A first wireless device may transmit, to a second wireless device, a codeword corresponding to a set of information bits encoded using a polar code, and the second wireless device may obtain a first set of log likelihood ratios (LLRs) based on performing a first decoding operation on the codeword. In cases that the first wireless device identifies a failure of the second wireless device to decode one or more of the information bits, the first wireless device may retransmit a subset of the information bits to the second wireless device independently of the polar code. The second wireless device may then attempt to decode the codeword a second time using the polar code and based on a combination of a first set of LLRs and a second set of LLRs corresponding to the subset of the information bits.

### FIELD OF TECHNOLOGY

The following relates to wireless communications, including rateless polar codes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support rateless polar codes. In particular, the described techniques provide for retransmissions in cases that a codeword is encoded using a rateless polar code. For example, a first wireless device may transmit, to a second wireless device, a codeword corresponding to a set of information bits encoded using a rateless polar code. The second wireless device may perform a decoding operation on the received codeword (e.g., using the polar code) to obtain a first set of log likelihood ratios (LLRs) corresponding to the set of information bits. In cases where the first wireless device identifies that the second wireless device failed to decode one or more of the information bits, the first wireless device may retransmit a subset of the information bits to the second wireless device. The first wireless device may select the subset of the information bits based on an order of a likelihood of error associated with a set of bit-channels used for encoding the set of information bits using the polar code. For example, the first wireless device may retransmit the subset of the information bits that are associated with the highest likelihoods of error (e.g., based on the polar code used to encode the information bits).

Additionally, the first wireless device may retransmit the subset of the information bits independently of the polar code. For example, the first wireless device may retransmit the subset of the information bits unencoded, or encoded using a new code. New codes may include, for example, a different code such as a low density parity check (LDPC) code, or a different (e.g., different code parameters such as code length) polar code. The second wireless device may attempt to decode the codeword a second time using a combination of a first set of LLRs (e.g., obtained based on attempting to decode the initial transmission of the codeword) and a second set of LLRs (e.g., that correspond to the subset of the information bits received in the retransmission).

A method for wireless communication at a first wireless device is described. The method may include transmitting, via a channel between the first wireless device and a second wireless device, a codeword corresponding to a set of multiple information bits encoded using a polar code and transmitting, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

An apparatus for wireless communication at a first wireless device is described. The apparatus may include a processor, memory coupled with the processor, and instructions stored in the memory. The instructions may be executable by the processor to cause the apparatus to transmit, via a channel between the first wireless device and a second wireless device, a codeword corresponding to a set of multiple information bits encoded using a polar code and transmit, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

Another apparatus for wireless communication at a first wireless device is described. The apparatus may include means for transmitting, via a channel between the first wireless device and a second wireless device, a codeword corresponding to a set of multiple information bits encoded using a polar code and means for transmitting, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

A non-transitory computer-readable medium storing code for wireless communication at a first wireless device is described. The code may include instructions executable by a processor to transmit, via a channel between the first wireless device and a second wireless device, a codeword corresponding to a set of multiple information bits encoded using a polar code and transmit, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

Some examples of the method, apparatuses, and non-transitory computer-readable medium described herein may further include operations, features, means, or instructions for receiving, from the second wireless device, signaling indicating the failure of the second wireless device to decode the one or more information bits, where identifying the failure may be based on receiving the signaling.

Some examples of the method, apparatuses, and non-transitory computer-readable medium described herein may further include operations, features, means, or instructions for identifying the failure may be based on identifying that a capacity of the channel may be less than a rate of the codeword transmitted over the channel.

Some examples of the method, apparatuses, and non-transitory computer-readable medium described herein may further include operations, features, means, or instructions for receiving, from the second wireless device, signaling indicating a difference between the capacity of the channel and the rate of the codeword, where identifying the failure may be based on receiving the signaling.

Some examples of the method, apparatuses, and non-transitory computer-readable medium described herein may further include operations, features, means, or instructions for receiving, from the second wireless device, signaling indicating an estimation of the channel, where identifying the failure may be based on the capacity of the channel corresponding to the estimation of the channel being less than the rate of the codeword.

Some examples of the method, apparatuses, and non-transitory computer-readable medium described herein may further include operations, features, means, or instructions for encoding the subset of the set of multiple information bits using a second code that may be different from the polar code to generate a second codeword, where transmitting the subset of the set of multiple information bits further includes transmitting the second codeword.

Some examples of the method, apparatuses, and non-transitory computer-readable medium described herein may further include operations, features, means, or instructions for transmitting, to the first wireless device, signaling indicating one or more parameters associated with the second code, where transmitting the second codeword may be based on transmitting the signaling.

In some examples of the method, apparatuses, and non-transitory computer-readable medium described herein, the one or more parameters include a quantity of information bits associated with the second code, a rate of the second code, or both.

In some examples of the method, apparatuses, and non-transitory computer-readable medium described herein, each of the subset of the set of multiple information bits may be encoded using the polar code with a respective subset of the set of multiple bit-channels and each of the subset of the set of multiple bit-channels may be associated with a higher likelihood of error than a second subset of the set of multiple bit-channels that may be disjoint from the subset of the set of multiple bit-channels.

Some examples of the method, apparatuses, and non-transitory computer-readable medium described herein may further include operations, features, means, or instructions for transmitting, after transmitting the subset of the set of multiple information bits and independently of the polar code, a second subset of the set of multiple information bits based on identifying a second failure of the second wireless device to decode one or more information bits of the set of multiple information bits, where the second subset of the set of multiple information bits may be selected based on the order of the likelihood of error, the subset of the set of multiple information bits, or a combination thereof.

A method for wireless communication at a first wireless device is described. The method may include receiving, via a channel between the first wireless device and a second wireless device, a codeword corresponding to a set of multiple information bits, obtaining a first set of multiple log likelihood ratios (LLRs) associated with the set of multiple information bits based on performing a first decoding operation on the codeword using a polar code, receiving, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code, and performing, on the codeword, a second decoding operation using the polar code and a combination of the first set of multiple LLRs and the second set of multiple LLRs.

An apparatus for wireless communication at a first wireless device is described. The apparatus may include a processor, memory coupled with the processor, and instructions stored in the memory. The instructions may be executable by the processor to cause the apparatus to receive, via a channel between the first wireless device and a second wireless device, a codeword corresponding to a set of multiple information bits, obtain a first set of multiple log likelihood ratios (LLRs) associated with the set of multiple information bits based on performing a first decoding operation on the codeword using a polar code, receive, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code, and perform, on the codeword, a second decoding operation using the polar code and a combination of the first set of multiple LLRs and the second set of multiple LLRs.

Another apparatus for wireless communication at a first wireless device is described. The apparatus may include means for receiving, via a channel between the first wireless device and a second wireless device, a codeword corresponding to a set of multiple information bits, means for obtaining a first set of multiple log likelihood ratios (LLRs) associated with the set of multiple information bits based on performing a first decoding operation on the codeword using a polar code, means for receiving, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code, and means for performing, on the codeword, a second decoding operation using the polar code and a combination of the first set of multiple LLRs and the second set of multiple LLRs.

A non-transitory computer-readable medium storing code for wireless communication at a first wireless device is described. The code may include instructions executable by a processor to receive, via a channel between the first wireless device and a second wireless device, a codeword corresponding to a set of multiple information bits, obtain a first set of multiple log likelihood ratios (LLRs) associated with the set of multiple information bits based on performing a first decoding operation on the codeword using a polar code, receive, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code, and perform, on the codeword, a second decoding operation using the polar code and a combination of the first set of multiple LLRs and the second set of multiple LLRs.

Some examples of the method, apparatuses, and non-transitory computer-readable medium described herein may further include operations, features, means, or instructions for transmitting, to the second wireless device, signaling indicating the failure of the first wireless device to decode the one or more information bits, where receiving the second set of multiple LLRs may be based on transmitting the signaling.

Some examples of the method, apparatuses, and non-transitory computer-readable medium described herein may further include operations, features, means, or instructions for transmitting, to the second wireless device, signaling indicating a difference between a capacity of the channel and a rate of the codeword transmitted over the channel, where receiving the second set of multiple LLRs may be based on transmitting the signaling.

Some examples of the method, apparatuses, and non-transitory computer-readable medium described herein may further include operations, features, means, or instructions for transmitting, to the second wireless device, signaling indicating an estimation of the channel, where receiving the second set of multiple LLRs may be based on transmitting the signaling.

Some examples of the method, apparatuses, and non-transitory computer-readable medium described herein may further include operations, features, means, or instructions for decoding, using a second code that may be different from the polar code, a second codeword to obtain the second set of multiple LLRs, where receiving the second set of multiple LLRs further includes receiving the second codeword.

Some examples of the method, apparatuses, and non-transitory computer-readable medium described herein may further include operations, features, means, or instructions for receiving, from the second wireless device, signaling indicating one or more parameters associated with the second code, where receiving the second codeword may be based on receiving the signaling.

In some examples of the method, apparatuses, and non-transitory computer-readable medium described herein, the one or more parameters include a quantity of information bits associated with the second code, a rate of the second code, or both.

Some examples of the method, apparatuses, and non-transitory computer-readable medium described herein may further include operations, features, means, or instructions for combining the second set of multiple LLRs with a subset of the first set of multiple LLRs to obtain a third set of multiple LLRs, where each LLR in the subset of the first set of multiple LLRs corresponds to an information bit in the subset of the set of multiple information bits, and where performing the second decoding operation may be based on the combining.

Some examples of the method, apparatuses, and non-transitory computer-readable medium described herein may further include operations, features, means, or instructions for performing the second decoding operation may be based on a first sign of at least one LLR in the third set of multiple LLRs being different from a second sign of at least one corresponding LLR in the subset of the first set of multiple LLRs.

Some examples of the method, apparatuses, and non-transitory computer-readable medium described herein may further include operations, features, means, or instructions for refraining from performing the second decoding operation on one or more bits of the codeword based on signs of one or more LLRs in the third set of multiple LLRs being the same as signs of one or more corresponding LLRs in the subset of the first set of multiple LLRs and initiating the second decoding operation based on the first sign of the at least one LLR in the third set of multiple LLRs being different from the second sign of the at least one corresponding LLR in the subset of the first set of multiple LLRs.

In some examples of the method, apparatuses, and non-transitory computer-readable medium described herein, each of the subset of the set of multiple information bits may be decoded using the polar code with a respective subset of the set of multiple bit-channels and each of the subset of the set of multiple bit-channels may be associated with a higher likelihood of error than a second subset of the set of multiple bit-channels that may be disjoint from the subset of the set of multiple bit-channels.

Some examples of the method, apparatuses, and non-transitory computer-readable medium described herein may further include operations, features, means, or instructions for receiving, after receiving the subset of the set of multiple information bits and based on a second failure of the first wireless device to decode one or more information bits of the set of multiple information bits, a second subset of the set of multiple information bits corresponding to a respective third set of multiple LLRs that may be independent of the polar code, where a second index associated with each information bit in the second subset of the set of multiple information bits may be identified based on the order of the likelihood of error, the subset of the set of multiple information bits, or a combination thereof.

### BRIEF DESCRIPTION OF THE DRAWINGS

FIG. 1 illustrates an example of a wireless communications system that supports rateless polar codes in accordance with one or more aspects of the present disclosure.

FIG. 2 illustrates an example of a wireless communications system that supports rateless polar codes in accordance with one or more aspects of the present disclosure.

FIG. 3 illustrates an example of an encoding scheme that supports rateless polar codes in accordance with one or more aspects of the present disclosure.

FIG. 4 illustrates an example of a retransmission scheme that supports rateless polar codes in accordance with one or more aspects of the present disclosure.

FIG. 5 illustrates an example of a process flow that supports rateless polar codes in accordance with one or more aspects of the present disclosure.

FIGS. 6 and 7 illustrate block diagrams of devices that support rateless polar codes in accordance with one or more aspects of the present disclosure.

FIG. 8 illustrates a block diagram of a communications manager that supports rateless polar codes in accordance with one or more aspects of the present disclosure.

FIG. 9 illustrates a diagram of a system including a device that supports rateless polar codes in accordance with one or more aspects of the present disclosure.

FIGS. 10 and 11 illustrate block diagrams of devices that support rateless polar codes in accordance with one or more aspects of the present disclosure.

FIG. 12 illustrates a block diagram of a communications manager that supports rateless polar codes in accordance with one or more aspects of the present disclosure.

FIG. 13 illustrates a diagram of a system including a device that supports rateless polar codes in accordance with one or more aspects of the present disclosure.

FIGS. 14 through 19 illustrate flowcharts showing methods that support rateless polar codes in accordance with one or more aspects of the present disclosure.

### DETAILED DESCRIPTION

In some wireless communications systems, a wireless device may use a rateless polar code to generate a codeword associated with a set of information bits for a multiple incremental redundancy scheme (MIRS). A MIRS may be associated with a dynamic rate adaptation to utilize channel capacity more efficiently (e.g., as compared to a static rate adaptation). In the example of rateless polar coding, which may be an example of a MIRS, the wireless device may select a rate associated with the polar code that exceeds a channel capacity (e.g., there may be a gap to capacity associated with transmitting the codeword). Because the rate associated with the polar code exceeds the channel capacity, a wireless device receiving the codeword may be unable to decode one or more of the set of information bits. In some cases, a mechanism for the receiving wireless device to provide feedback about the failure to decode one or more set of information bits (e.g., a negative acknowledgment (NACK) transmission) may not be defined for rateless polar coding. For example, there may not be signaling defined that enables a receiving wireless device to indicate which of the set of information bits the receiving wireless device is unable to decode. Additionally, or alternatively, transmitting feedback indicating the failure (e.g., and which bits are associated with the failure) may increase latency and bandwidth associated with communications between the transmitting and receiving wireless devices.

As described herein, the transmitting and receiving wireless devices may rely on properties of polar codes to identify one or more information bits for retransmission in cases that the receiving wireless device fails to decode one or more of the information bits. In particular, the transmitting wireless device may identify a subset of the information bits that the receiving device is likely to have failed to decode based on the polar code. That is, the bit-channels used for encoding the information bits using the polar code (e.g., to generate the codeword) may each be associated with a corresponding likelihood of error that is a characteristic of the polar code. Thus, the transmitting wireless device may select the subset of information bits by selecting a quantity of the information bits that are associated with a higher likelihood of error than the other (e.g., unselected) information bits. The transmitting wireless device may also identify a quantity of information bits to include in the subset based on the gap to capacity or a difference between the rate of the polar code and a capacity of the channel between the transmitting and receiving wireless devices.

The transmitting wireless device may then transmit the subset of information bits to the receiving wireless device independently of the polar code (e.g., without encoding the identified information bits using the same polar code). Then, the receiving wireless device may combine soft information (e.g., log likelihood ratios (LLRs)) associated with the retransmitted information bits with soft information associated with the one or more bits that the receiving device failed to decode, and attempt to decode the codeword using the combined soft information.

Aspects of the disclosure are initially described in the context of wireless communications systems. Aspects of the disclosure are then described in the context of an encoding scheme, a retransmission scheme, and a process flow. Aspects of the disclosure are further illustrated by and described with reference to apparatus diagrams, system diagrams, and flowcharts that relate to rateless polar codes.

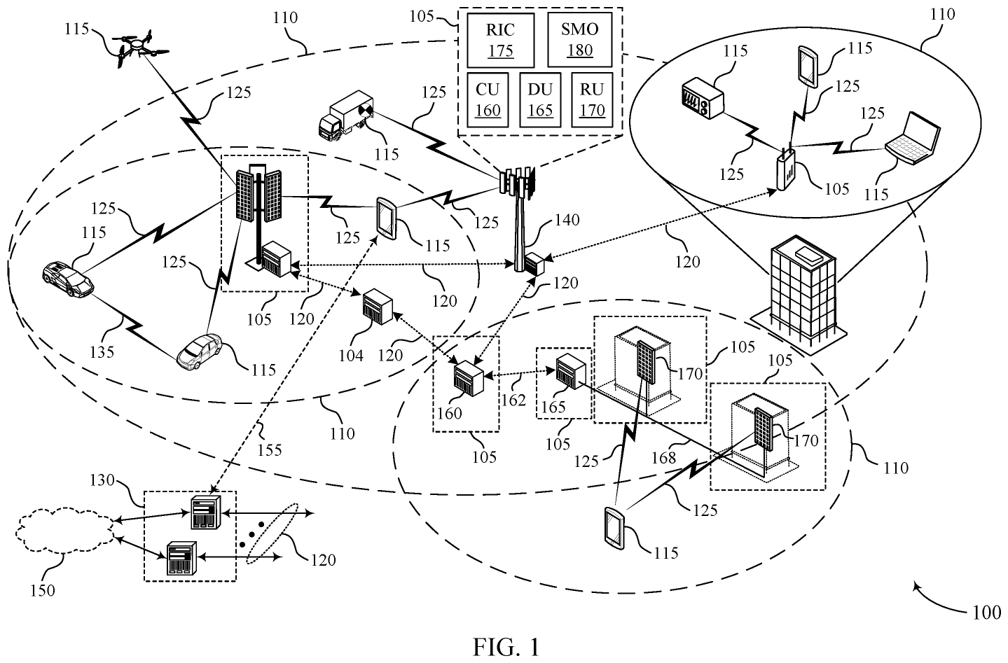

FIG. 1 illustrates an example of a wireless communications system 100 that supports rateless polar codes in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support rateless polar codes as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM

(DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a wireless device (e.g., a network entity 105, a UE 115) may encode information bits to generate a codeword using a rateless code (e.g., a rateless scheme). In a rateless scheme, a wireless device may adapt an amount of redundant data (e.g., included in the codeword) over different resources (e.g., time resources, frequency resources, spatial resources) in response to varying channel conditions. In some cases, rateless schemes may be associated with improved efficiencies (e.g., use of channel capacity) as compared to fixed-rate schemes (e.g., where an amount of redundant data is static or adapted slowly such as using a feedback loop based on metrics of decoded blocks such as block error rate (BLER)). For example, signals associated with additive white gaussian noise (AWGN) that are encoded using a rateless scheme may be associated with improved performance (e.g., improved capacity utilization, decreased error rates) as compared to similar signals that are encoded without using a rateless scheme. Additionally, the rateless scheme may be associated with an improved capability of bit loading (e.g., as compared to a fixed-rate scheme), which may yield increased efficiency in frequency selective and time selective channels. In some cases, in addition to improving a rate selection (e.g., a modulation and coding scheme (MCS) selection), rateless schemes may also enable wireless devices to dynamically select a precoding matrix indicator (PMI) and rank indicator (RI) for transmissions.

In some cases, wireless devices may employ a MIRS, which may be an example of a rateless scheme, to generate a codeword associated with a set of information bits. A MIRS may be associated with a dynamic rate adaptation to utilize channel capacity more efficiently (e.g., as compared to a static rate adaptation). In some wireless communications systems 100, a MIRS may rely on current channel estimations to select a rate for the scheme. For example, the wireless devices may estimate the channel between the transmitting and receiving wireless devices based on a channel state information-reference signal (CSI-RS). In some cases, a MIRS that is based on CSI-RS may not estimate the channel correctly or efficiently. For example, the channel estimation may be performed at discrete times (e.g., corresponding to CSI-RS slots), which may cause channel prediction or estimation to be difficult and not accurate.

In some cases, the MIRS may be based on rate adaptation that does not rely on current channel estimation (e.g., channel estimation based on CSI-RS), which may improve the capacity even in cases of relatively high mobility (e.g., in cases that one or both of a transmitting and receiving wireless device are moving). Instead, a MIRS may rely on an incremental redundancy HARQ (IR-HARQ) scheme. For example, a first transmission may correspond to a highest speculated rate (e.g., MCS) for a current channel (e.g., between a transmitting and receiving wireless device). That is, the transmitting device may encode the first transmission using a code having a rate that corresponds to a highest anticipated (e.g., estimated) channel between the transmitting and receiving wireless devices. In cases that a capacity of the channel between the transmitting and receiving wireless devices is less than the highest estimation of the channel, the receiving device may be unable to decode the first transmission (e.g., because the capacity of the channel is less than the rate associated with the code used to encode the first transmission). In some cases, when the capacity of the channel is less than the rate of the code used to encode a transmission transmitted via the channel, there may be a gap to capacity.

In response being unable to decode a transmission from the transmitting wireless device, the receiving wireless device may transmit HARQ feedback (e.g., a NACK transmission). The transmitting device may add incrementally more redundancy using subsequent retransmissions until the receiving wireless device successfully decodes the transmission (e.g., and the receiving wireless device transmits HARQ ACK (acknowledgment) feedback). Here, the receiving wireless device may transmit continuous HARQ feedback (e.g., ACK or NACK transmissions in response to each transmission and retransmission from the transmitting wireless device) and the transmitting wireless device may determine whether to transmit another retransmission (e.g., including more redundancy than each of the previous transmissions) based on the continuous HARQ feedback. Additionally, or alternatively, the transmitting wireless device may adjust other parameters of the transmissions and retransmissions (e.g., precoding) based on the continuous HARQ feedback. By employing the MIRS using IR-HARQ, the wireless devices may communicate at a capacity code rate even in cases that one or both of the transmitting and receiving wireless devices are mobile.

In the example of rateless polar coding, which may be an example of a MIRS, the wireless device may select a rate associated with the polar code that exceeds a channel capacity (e.g., there may be a gap to capacity associated with transmitting the codeword). Because the rate associated with the polar code exceeds the channel (e.g., the channel capacity is exceeded), a wireless device receiving the codeword may be unable to decode one or more of the set of information bits. In some cases, a mechanism for the receiving wireless device to provide feedback about the failure to decode one or more set of information bits (e.g., a NACK transmission) may not be defined for rateless polar coding. For example, there may not be signaling defined that enables a receiving wireless device to indicate which of the set of information bits the receiving wireless device is unable to decode. Additionally, or alternatively, transmitting feedback indicating the failure (e.g., and which bits are associated with the failure) may increase latency and bandwidth associated with communications between the transmitting and receiving wireless devices.

In the example of the wireless communications system 100, the transmitting and receiving wireless devices may rely on properties of polar codes to identify one or more information bits for retransmission in cases that the receiving wireless device fails to decode one or more of the information bits. In particular, the transmitting wireless device may identify a subset of the information bits that the receiving device is likely to have failed to decode based on the polar code and without the receiving wireless device indicating the subset of bits to the transmitting wireless device. For example, the bit-channels used for encoding the information bits using the polar code (e.g., to generate the codeword) may each be associated with a corresponding likelihood of error that is a characteristic of the polar code. Thus, the transmitting wireless device may select the subset of information bits by selecting a quantity of the information bits that are associated with a higher likelihood of error than the other (e.g., unselected) information bits. The transmitting wireless device may also identify a quantity of information bits to include in the subset based on the gap to capacity or a difference between the rate of the polar code and a capacity of the channel between the transmitting and receiving wireless devices.

The transmitting wireless device may then transmit the subset of information bits to the receiving wireless device independently of the polar code (e.g., without encoding the identified information bits using the same polar code). Then, the receiving wireless device may combine the LLRs associated with the retransmitted information bits with LLRs associated with the one or more bits that the receiving device failed to decode, and attempt to decode the codeword using the combined LLRs.

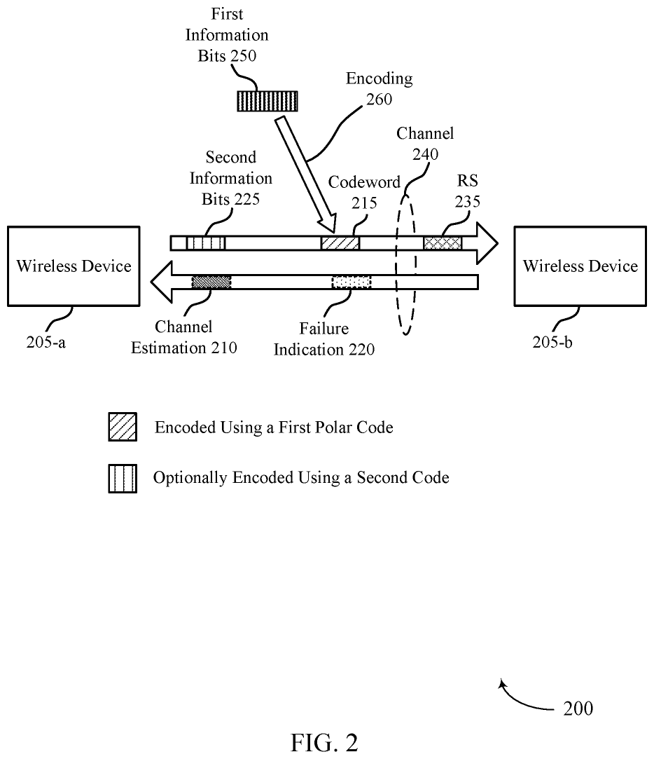

FIG. 2 illustrates an example of a wireless communications system 200 that supports rateless polar codes in accordance with one or more aspects of the present disclosure. In some examples, the wireless communications system 200 may implement aspects of wireless communications system 100. The wireless communications system 200 may include wireless devices 205, which may be examples of UEs 115 or network entities 105, as described with reference to FIG. 1. In some cases, the wireless device 205-a may transmit codewords (e.g., including the codeword 215) that are encoded using a rateless polar code.

To transmit the codeword 215 to the wireless device 205-b according to a rateless scheme, the wireless device 205-a may first estimate a capacity C of a channel 240 between the wireless devices 205. In one example, the wireless device 205-b may transmit, to the wireless device 205-a, signaling indicating a channel estimation 210 of the channel 240 between the wireless devices 205. For example, the wireless device 205-a may transmit a reference signal 235 (e.g., a CSI-RS, another type of reference signal) to the wireless device 205-b via the channel. The wireless device 205-b may then perform a channel estimation of the channel using the received reference signal 235, and transmit signaling indicating the channel estimation 210 to the wireless device 205-a. In response to receiving the signaling indicating the channel estimation 210 from the wireless device 205-b, the wireless device 205-a may estimate the capacity C of the channel.

The wireless device 205-a may perform encoding 260 on a first set of information bits 250 using a polar code to generate the codeword 215. In an example of a rateless scheme, the wireless device 205-a may encode the first set of information bits 250 (e.g., and one or more frozen bits) using a polar code with a rate R₀ that is greater than the estimated capacity of the channel C. In some cases, the wireless device 205-a may select the rate R₀ to not be more than a threshold amount larger than the estimated capacity of the channel C, which may mitigate rate loss and increase in latency in communications between the wireless devices 205. In some cases, the wireless device 205-a may assign each information bit to a respective bit-channel of the polar code. Each bit in the codeword 215 may be encoded using a different one of a set of bit-channels of the polar code.

Based on encoding the first set of information bits 250 to generate the codeword 215, the wireless device 205-a may transmit the polar encoded codeword 215 to the wireless device 205-b via the channel 240. The wireless device 205-b may monitor the channel 240 for transmissions from the wireless device 205-a. Based on monitoring the channel, the wireless device 205-b may detect the codeword 215 and perform a decoding process (e.g., successive cancellation (SC) decoding) using the polar code. In some cases, the wireless device 205-b may use a list decoder (e.g., a successive cancellation list (SCL) decoder) for decoding the codeword 215.

Based on the received codeword 215, the wireless device 205-b (e.g., a decoder included in the wireless device 205-b) may determine a received LLR for each of the bit-channels. The wireless device 205-b (e.g., an SCL decoder included in the wireless device 205-b) may perform a list decoding operation on the set of received LLRs. Based on the sequential order of decoding, the wireless device 205-b may decode a first bit channel based on the set of received LLRs and determine a decoded LLR for the first bit channel. The wireless device 205-b may use the decoded LLRs to calculate subsequent decoded LLRs associated with remaining bit-channels.

In cases that the wireless device 205-b is unable to decode the codeword 215 (e.g., due to a gap to capacity where the rate R₀ is greater than a capacity C of the channel 240), the wireless device 205-a may identify the failure of the wireless device 205-b to decode the codeword 215. For example, the wireless device 205-a may identify the failure based on a failure of an error check (e.g., CRC failure), which may indicate that the capacity C of the channel is less than the rate R₀ of the codeword 215. For example, the wireless device 205-b may transmit signaling to the wireless device 205-a indicating that the capacity C of the channel is less than the rate R₀ of the codeword 215 (e.g., indicating a presences of a gap to capacity). Additionally, or alternatively, the wireless device 205-b may transmit signaling indicating a difference between the capacity C of the channel and the rate R₀ of the codeword 215 (e.g., indicating a value of the gap to capacity). Additionally, the wireless device 205-a may identify a presence of the gap to capacity based on a channel estimation 210. For example, the wireless device 205-a may determine that the capacity C of the channel is less than the rate R₀ of the codeword 215 based on the channel estimation 210 indicating an estimated channel capacity that is less than the rate R₀ of the codeword 215. Additionally or alternatively, the capacity C of the channel may be determined based on mutual information (MI) calculated from the LLRs. For example, the capacity C may be determined according to Equation 1.

$$P = 1 / ( 1 + {e}^{( - \vert LLR \vert )} ) \\ MI = 1 - [ - P \cdot {log}_{2} ( P ) - ( 1 - P ) \cdot {log}_{2} ( 1 - P ) ] \\ C [ bits ] = sum ( MI ) \qquad ( 1 )$$

Additionally, the wireless device 205-a may identify the failure of the wireless device 205-b to decode the codeword 215 based on the wireless device 205-b transmitting signaling including a failure indication 220. For example, the wireless device 205-b may transmit the failure indication 220 via HARQ NACK signaling that indicates, to the wireless device 205-a, the failure of the wireless device 205-b to decode the initial or first transmission of the codeword 215. In some cases, the failure indication 220 may not include an indication of the one or more information bits or LLRs associated with the codeword 215 that the wireless device 205-b is unable to decode, which may decrease an overhead associated with the failure indication 220 as compared to failure indications 220 that do include an indication of the one or more information bits or bit channel indices. That is, the failure indication 220 may not include bit channel indices of information bits associated with errors in decoding the codeword 215.

In response to identifying the failure of the wireless device 205-b to decode one or more of the information bits in the codeword 215, the wireless device 205-b may select a subset of the information bits (e.g., the second set of information bits 225) to retransmit to the wireless device 205-b. The wireless device 205-b may determine a quantity of the information bits to retransmit based on the gap to capacity. For example, the wireless device 205-b may determine how many information bits the wireless device 205-a is likely to have been unable to decode based on the difference between the channel capacity C and the rate R₀ of the codeword 215. In some examples, the quantity of retransmitted information bits (Ib_{RET}) may be determined according to Equation 2.

$${Ib}_{RET} = ( {R}_{0} - C ) \cdot n \qquad ( 2 )$$

where n is the length (e.g., number of bit-channels) of the polar code. Or, where the channel capacity C is measured in bits, according to Equation 3.

$${Ib}_{RET} = {R}_{0} \cdot n - C \qquad ( 3 )$$

The number of retransmitted bits Cb_{RET} may be determined according to Equation 4.

$${Cb}_{RET} = ( ( {R}_{0} - C ) \cdot n ) / {R}_{1} \qquad ( 4 )$$

where R₁ is the rate of a second code used for encoding the retransmitted information bits (e.g., where R₁=1 for uncoded retransmission).

Additionally, to identify which of the first set of information bits 250 the wireless device 205-b is likely to have failed to decode, the wireless device 205-a may rely on a characteristic of the polar code. That is, each of the bit-channels used to encode the information bits to generate the codeword 215 may be associated with a characteristic (e.g., a known) likelihood of error. Accordingly, the wireless device 205-a may select the second set of information bits 225 to retransmit based on the information bits that are encoded using bit-channels associated with a higher likelihood of error than the remaining (e.g., not retransmitted) information bits. Additionally, the wireless device 305-a may refrain from retransmitting the remaining information bits that are encoded using bit-channels associated with lower likelihoods of error (e.g., a subset that is disjoint from the second set of information bits 225 that are retransmitted).

After selecting the second set of information bits 225 for retransmission (e.g., according to an order of a likelihood of error associated with bit-channels used for encoding the information bits), the wireless device 205-a may retransmit the second set of information bits 225 to the wireless device 205-b. The wireless device 205-a may retransmit the second set of information bits 225 independently of the polar code used to generate the codeword 215 (e.g., without encoding the second set of information bits 225 using the polar code used to generate the codeword 215).

In some cases, the wireless device 205-a may encode the second set of information bits 225 using another code (e.g., a different code than the polar code used to generate the codeword 215). For example, the wireless device 205-a may generate a second codeword by encoding the second set of information bits 225 using the other code and may transmit the second set of information bits 225 to the wireless device 205-b via the second codeword. For example, the wireless device 205-a may encode the second set of information bits 225 using a different type of code (e.g., a convolutional code, an LDPC code). In another example, the wireless device 205-a may encode the second set of information bits 225 using a different polar code (e.g., different from the polar code used to generate the codeword 215). In cases that the wireless device encodes the second set of information bits 225, the code used to encode the second set of information bits 225 may be known to both the wireless device 205-a and the wireless device 205-b (e.g., predefined, preconfigured). Additionally, the wireless device 205-a may optionally transmit signaling indicating one or more parameters associated with the code used to encode the second set of information bits 225. For example, the wireless device 205-a may transmit signaling, to the wireless device 205-b, signaling indicating a quantity of the second set of information bits 225, a rate of the code used to encode the second set of information bits 225, or other parameters associated with the code.

The wireless device 205-b may attempt to decode the codeword 215 again based on receiving transmission including the second set of information bits 225. For example, the wireless device 205-b may identify the LLRs that are received (e.g., each corresponding to one of the second set of information bits 225 transmitted by the wireless device 205-a). In some cases (e.g., in cases that the wireless device 205-a transmits the second set of information bits 225 via a second codeword), to identify the LLRs the wireless device 205-b may perform a soft decoding operation on the second codeword to identify the LLRs each corresponding to one of the second set of information bits 225.

The wireless device 205-b may combine the received LLRs associated with each of the second set of information bits 225 with the LLRs obtained during a previous decoding operation (e.g., performed on the codeword 215). For example, the wireless device 205-b may perform respective summation operations between the LLRs associated with the second set of information bits 225 and the corresponding LLRs obtained during the decoding operation performed on the codeword 215. In some cases, the wireless device 205-b may perform a full decoding operation on the codeword 215 based on the combined LLRs. For example, the wireless device 205-b may perform an SCL decoding operation to identify decoded LLRs associated with each of the bit-channels of the codeword 215.

In some other cases, the wireless device 205-b may perform a partial decoding operation on the codeword 215 based on the combined LLRs. For example, the wireless device 205-b may determine updated decoded LLRs for any combined LLRs having a different sign than previously-identified received LLRs. That is, until a combined LLR has a different sign than the received LLR associated with the codeword 215, the wireless device 205-a may refrain from determining an updated decoded LLR for that bit-channel. For example, if the received LLR associated with the first bit-channel has a same sign as the combined LLR associated with the first bit-channel, the wireless device 205-b may refrain from propagating the combined LLR using the SC or SCL decoder. Instead, the wireless device 205-b may determine a first (e.g., in bit-channel order) bit-channel where the combined LLR is different from the received LLR from the codeword 215, and may then re-start the SC or SCL decoder from the first bit-channel using the combined LLRs for that and remaining bit-channels to determine of the combined LLRs result in a successful decoding.

In cases that the wireless device 205-b successfully decodes the codeword 215 after receiving the second set of information bits 225 and performing the second decoding operation on the codeword 215, the wireless device 205-a may refrain from retransmitting additional sets of information bits. Alternatively, in cases that the wireless device 205-b fails to decode the codeword 215 after receiving the second set of information bits 225, the wireless device 205-a may retransmit another subset of the information bits. For example, the wireless device 205-a may select information bits (e.g., a third set of information bits that are different from the second set of information bits 225) to retransmit based on the order of the likelihood of error associated with the bit-channels used for encoding the information bits. The wireless device 205-a may continue retransmitting subsets of the information bits until the wireless device 205-b successfully decodes the codeword 215.

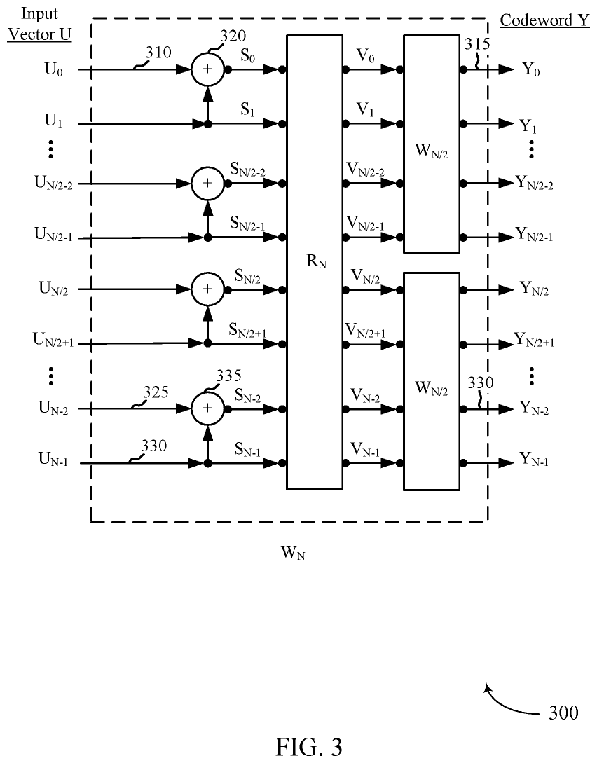

FIG. 3 illustrates an example of an encoding scheme 300 that supports rateless polar codes in accordance with one or more aspects of the present disclosure. The encoding scheme 300 may implement a polar coding scheme in accordance with the techniques described herein. For example, the encoding scheme 300 may be implemented by a wireless device as described with reference to FIGS. 1 and 2, to encode and decode information bits.

The channels (e.g., W) may be a binary-input discrete memoryless channels (e.g., W: U→Y, where U represents input and Y represents output). The capacity of the channels may be represented by C=I(U; Y) and for the example of binary-input, 0≤C≤1, where C=I(U; Y) denotes mutual information and may be referred to as a mutual information polarization function.

In some wireless communications systems, channel polarization may be used to create an auxiliary channel to achieve coding gain beyond repetition. A wireless device may apply channel polarization (e.g., a polarizing transform) to obtain multiple instances of the channel (e.g., bit-channels), where each bit-channel is associated with a capacity. A bit-channel may also be referred to as a polarization level, such that a polarizing transform may be associated with a quantity of polarization levels N.

Generally, a polarizing transform may be any arbitrary N×N matrix, and N may be any integer, provided that the matrix is a binary transform and is invertible. In some examples, such as the example illustrated in FIG. 3, a polarizing transform may be an example of a polar code and may be based on a polar kernel. For example, a polarizing transform based on a polar kernel may have N polarization levels, and may be represented by a tensor power of a 2×2 matrix

$$( \begin{matrix}1 & 0 \\ 1 & 1\end{matrix} )$$

with dimensions 2^{N}×2^{N}.

In some examples, the capacity of each bit-channel of a polarizing transform may not be the same as another bit-channel. For example, for binary input bit-channels, bit-channels of punctured bits may have C=0, bit-channels of shortened bits may have C=1, and bit-channels transmitted over a given AWGN channel may have a C of the corresponding channel. A higher value of C may correspond to a higher capacity, where a higher capacity indicates that the bit-channel supports a relatively higher rate in terms of bits per channel use (e.g., for a single transmission over a wireless medium) at which information can be sent with an arbitrarily low probability of error. Put another way, a relatively high capacity may correspond to a relatively high channel quality and a relatively higher reliability metric (e.g., and a relatively lower likelihood for error associated with that bit-channel).

For example, for the channel W, a device may apply a polarizing transform to obtain a bit-channel W₁ and a bit-channel W₂. W₂ may have a higher capacity than W₁ and may thus be considered to have a better channel quality and reliability than W₁ (e.g., W₂ may be decoded with a higher success rate, W₂ may be associated with a lower likelihood for error). The capacity of the unpolarized channel W may be represented by R, the capacity of the channel W₂ may be represented by W⁺, and the capacity of the channel W₁ may be represented by W⁻. The polarizing transform may be based on the mutual information polarization function C=I(U; Y). That is, outputs of the mutual information polarization function (e.g., Y) may polarize based on functions associated with the transform. A mutual information transfer chart or the like may be used to establish a relationship between W and W⁺/W⁻, and thus establish the polarization of the channel.

The above operation may be performed recursively, yielding more polarization across N bit-channels, where each bit-channel has a corresponding capacity and reliability. The wireless device may load (e.g., assign) bits to be transmitted to the bit-channels. In some cases, the device may load bits to bit-channels based on the reliability of each bit-channel. For example, the device may load information bits to W₂ and may load frozen or parity bits to W₁.

In some cases, a proportion of noiseless bit-channels converges to a channel capacity for values of N that are sufficiently large. That is, some of the bits in the codeword Y may be associated with a bit-channel having a bit error rate of 0 (e.g., a bit-channel having a channel capacity of 1). Additionally, or alternatively, some of the bits in the codeword Y may be associated with a bit-channel having a bit error rate of 0.5 (e.g., a bit-channel having a channel capacity of 0.5). An example of the convergence of the channel capacity for values of N that are sufficiently large is illustrated below by Equation 2.

$$\{ \begin{matrix}\vert {I}_{i} > 1 - ε \vert \\ \vert {I}_{i} < ε \vert \\ \vert ε < {I}_{i} < 1 - ε \vert\end{matrix} \begin{matrix}N \to ∞ \\ \to \end{matrix} \{ \begin{matrix}I ( U ; Y ) \\ 1 - I ( U ; Y ) \\ 0\end{matrix} \qquad ( 5 )$$

In the example of Equation 1, the indexes of the N bit-channels may be sorted given a capacity of the channel. In some cases, to transmit a codeword encoded using a polar code associated with a rate R, and to transmit data reliably (e.g., and associated with a large capacity and small bit error rate), a transmitting wireless device may encode the codeword Y using an encoding scheme 300 having K bit-channels, where K/N=R. Additionally, in the other N-K bit-channels (or bits of the codeword Y), the encoding scheme 300 may include bits having a known or fixed value (e.g., frozen bits).

In one example of an encoder for two bits, the polar kernel may be a [u+v, v] kernel. Examples of the polarizing transform for the two-bit encoder are shown below with reference to Equations 6 through 8.

$${G}_{[ u + v , v ] 2} = {F}_{u + v , v} = [ \begin{matrix}1 & 0 \\ 1 & 1\end{matrix} ] \qquad ( 6 )$$

$${U}_{1}^{2} \cdot {G}_{2} = {X}_{1}^{2} \qquad ( 7 )$$

$${X}_{1}^{2} \to {W}_{1}^{2} \to {Y}_{1}^{2} \qquad ( 8 )$$

More generally for a polar kernel that is a [u+v, v] kernel, Equations 9 through 11 may be examples of a polarizing transform for an N-bit encoder (e.g., where N is a power of two).

$${G}_{[ u + v , v ] N} = {B}_{[ binary ] N} \cdot {F}_{u + v , v}^{{⊗}_{n}} \qquad ( 9 )$$

$${U}_{0}^{N - 1} \cdot {G}_{N} = {X}_{0}^{N - 1} \qquad ( 10 )$$

$${X}_{0}^{N - 1} \to {W}_{0}^{N - 1} \to {Y}_{0}^{N - 1} \qquad ( 11 )$$

In the example of FIG. 3, the encoding scheme 300 may be associated with N bit-channels (e.g., polarization levels, encoding branches). The encoding scheme 300 may encode a set of bits U_{N} (including at least a portion of information bits) using a polar code (e.g., based on the polarizing transform, for example as described with reference to Equations 4 through 6). In this example, the encoding scheme 300 is associated with an N-bit encoder, and therefore receives an input vector U including a set of bits [U₀, U₁ . . . , U_{N-1}]. The encoding scheme 300 may encode the set of information bits and may output an N-bit output vector Y ([Y₀, Y₁, . . . , Y_{N-1}]), which may also be referred to as a codeword. Because the output vector has an equal quantity of bits as the input vector, the polar code example of FIG. 3 may be referred to as a one-to-one coding scheme. Coding schemes of other bit sizes may also be used and in some cases, the output vector may have a different length than that of the input vector (e.g., coding schemes other than one-to-one coding schemes may be applied).

The multiple bit-channels may each correspond to a bit location to which the encoding scheme 300 may assign corresponding bits i of the input vector U. As illustrated in FIG. 3, the encoding scheme 300 may load a bit U₀ to a bit location 0 corresponding to a first bit-channel, a bit U₁ to a bit location 1 corresponding to a second bit-channel, and so on, up to a bit U_{N-1} and a bit location N−1. A bit loaded to a bit location may undergo one or more operations (e.g., encoding operations) for the bit-channel. For example, the bit U₀ is received at input 310, three Boolean exclusive or (XOR) operations are performed (represented by a “+” symbol at element 320), and a bit X₀ of output vector X is output at 315.

Each bit-channel of encoding scheme 300 may perform zero or more encoding operations on bits U input to the bit-channel via the corresponding bit location i. Encoding a bit in one bit-channel may depend on bits input to one or more other bit-channels. For example, in the bit-channel corresponding to the bit location U_{N-2}, the encoding scheme 300 encodes bit U_{N-2} by performing XOR operations on bits U_{N-2} and U_{N-1}. Bit U_{N-2} is received at input 325 and bit U_{N-1} is received at input 330. At 335, the encoder performs an XOR operation on bits U_{N-2} and U_{N-1} and provides S_{N-2} at output 340. Put another way, S_{N-2}=U_{N-2} XOR U_{N-1}. The encoding scheme 300 performs similar operations in remaining bit-channels corresponding to bit locations U₀ to U_{N-1} encode corresponding bits of the input vector. After performing the encoding operations on the bits of the input vector, the encoding scheme 300 outputs the output vector Y such that Y includes a set of encoded bits [Y₀, Y₁ . . . , Y₇].

Because the encoding scheme 300 is an example of a polar encoder (e.g., the encoding scheme 300 applies a polarizing transform based on a polar kernel), the bit-channels corresponding to the bit locations U₀ to U_{N-1} (e.g., and the output vector Y) are polarized, such that each bit-channel may be associated with a capacity and a reliability. The device may distribute information bits (e.g., included in the input vector U) across the bit-channels based on associated reliabilities (e.g., based on a channel quality associated with each bit-channel). That is, the bits assigned to bit locations U₀ to U_{N-1} may have varying probabilities of successful decoding (e.g., based on the corresponding reliability of each bit location U₀ to U_{N-1}) once output Y is transmitted and received at a receiver. In some cases, the varying probabilities of successful decoding, or likelihoods for errors associated with each bit-channel may be a characteristic of the polar code, and may be known by both the transmitting and receiving wireless devices.

In the example of the encoding scheme 300, the transmitting and receiving wireless devices may rely on the properties of polar codes to identify one or more information bits for retransmission in cases that the receiving wireless device fails to decode one or more of the information bits U. In particular, the transmitting wireless device may identify a subset of the information bits U₀ to U_{N-1} that the receiving device is likely to have failed to decode based on the known likelihood for error associated with the corresponding bit-channel (e.g., and without the receiving wireless device indicating the subset of bits to the transmitting wireless device). Thus, the transmitting wireless device may select the subset of information bits by selecting a quantity of the information bits U that are associated with a higher likelihood of error than the other (e.g., unselected) information bits U.

The transmitting wireless device may also identify a quantity of information bits U to include in the subset based on the gap to capacity or a difference between the rate of the polar code and a capacity of the channel between the transmitting and receiving wireless devices. That is, to reduce a quantity of retransmission and HARQ buffer utilization, a quantity of information bits U included in the first retransmission may be based on the gap to capacity.

For example, a receiving wireless device may determine an average mutual information of LLRs associated with the codeword Y by averaging the mutual information of the generated or determined LLRs for the codeword (e.g., in the slot). In some cases, for each of the code blocks at the first transmission, the wireless devices may calculate the mutual information for the code block (e.g., the code block mutual information). To calculate the code block mutual information, the receiving wireless device may average the mutual information of each of the code block LLRs after any HARQ combining, including punctured LLRs (e.g., zero-valued LLRs of the HARQ buffer). In some cases, by averaging the mutual information of each of the code block LLRs, the receiving wireless device may identify a normalized metric with respect to a code block size and MCS.

Equations 12 through 17 illustrate example numerical mutual information calculations for a set of LLRs associated with a set of information bits.

$${LLR}_{i} = ln ( \frac{p ( 1 \vert {y}_{i} )}{p ( 0 \vert {y}_{i} )} ) \qquad ( 12 )$$

$$p ( 0 \vert {y}_{i} ) = \frac{1}{1 + exp ( {LLR}_{i} )} ; p ( 1 \vert {y}_{i} ) = 1 - p ( 0 \vert {y}_{i} ) \qquad ( 13 )$$

$$I ( x ; y ) = {\sum }_{y} {\sum }_{x} p ( x , y ) {log}_{2} ( \frac{p ( x , y )}{p ( x ) p ( y )} ) \qquad ( 14 )$$

$$I ( x ; y ) = {\sum }_{y} {\sum }_{x} p ( y ) p ( x \vert y ) {log}_{2} ( \frac{p ( x \vert y ) p ( y )}{p ( x ) p ( y )} ) \qquad ( 15 )$$

$$I ( x ; y ) = {\sum }_{y} p ( y ) {\sum }_{x} p ( x \vert y ) {log}_{2} ( 2 \cdot p ( x \vert y ) ) \qquad ( 16 )$$

$$I ( x ; y ) = \frac{1}{N} {\sum }_{i = 0}^{N - 1} ( \begin{matrix}p ( 0 \vert {y}_{i} ) \cdot {log}_{2} ( 2 \cdot p ( 0 \vert {y}_{i} ) ) + \\ p ( 1 \vert {y}_{i} ) \cdot {log}_{2} ( 2 \cdot p ( 1 \vert {y}_{i} ) )\end{matrix} ) \qquad ( 17 )$$

The receiving wireless device may determine a quantity of resources to achieve a target mutual information for a first retransmission (e.g., based on the gap to capacity) and may optionally signal the quantity of resources to the transmitting wireless device. Additionally, or alternatively, the transmitting wireless device may estimate the gap to capacity associated with the channel based on a channel estimation (e.g., indicated to the transmitting wireless device by the receiving wireless device). In either case, the transmitting wireless device may allocate a quantity of information bits U for the retransmission based on the gap to capacity.

The transmitting wireless device may then transmit the subset of information bits U (e.g., the input to the encoding scheme 300) to the receiving wireless device independently of the polar code (e.g., without encoding the identified information bits using the same polar code associated with the encoding scheme 300). Then, the receiving wireless device may combine the LLRs associated with the retransmitted information bits U with LLRs associated with the one or more information bits U that the receiving device failed to decode, and attempt to decode the codeword Y using the combined LLRs. That is, the receiving device may calculate the LLRs associated with the received retransmitted information bits U, and add those bit LLRs. For example, if the transmitting wireless device retransmits the information bit Uᵢ, the receiving wireless device may add the LLR_{UiReTx} to the original LLR_{Ui} the receiving wireless device calculated when attempting to decode the initial transmission of the codeword Y. In some cases, the receiving wireless device may perform a second decoding operation to decode the codeword Y from the first bit of the LLR having a sign that is flipped after adding the LLRs associated with the retransmitted information bits U.

In cases that the receiving wireless device fails to decode the codeword Y after receiving the subset of the retransmitted information bits U, the wireless devices may recalculate the gap to capacity of the channel and repeat a retransmission process. In some examples, the wireless devices may use f_{MIRS} of the resources associated with first transmission of the codeword Y (e.g., without the gap to capacity).

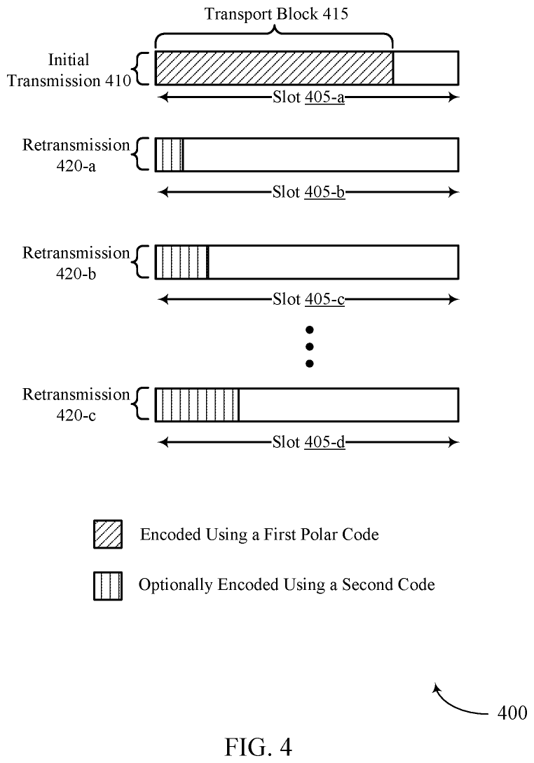

FIG. 4 illustrates an example of a retransmission scheme 400 that supports rateless polar codes in accordance with one or more aspects of the present disclosure. The retransmission scheme 400 may implement a polar coding scheme in accordance with the techniques described herein. For example, the retransmission scheme 400 may be implemented by a wireless device as described with reference to FIGS. 1 and 2. Additionally, the initial transmission 410 may be encoded according to the encoding scheme 300 described with reference to FIG. 3.

The initial transmission 410 may correspond to a codeword transmitted via the transport block 415 in the slot 405-a. In some cases, the initial transmission 410 may be encoded using a first polar code (e.g., as described with reference to FIGS. 1 through 3). For example, the initial transmission 410 may include a codeword that is generated by applying the first polar code to a set of information bits. In some cases, the transport block 415 may be transmitted according to a MIRS, where a rate of the first polar code (e.g., associated with an MCS) is selected by the transmitting wireless device and corresponds to a highest anticipated capacity C for a channel between the transmitting and a receiving wireless device.

In cases that the receiving wireless device is unable to decode the codeword included in the transport block 415 (e.g., due to the rate R associated with first polar code being greater than the capacity of the channel C), the transmitting wireless device may retransmit a subset of the information bits via a retransmission 420-a and within a subsequent slot 405-b. The transmitting wireless device may continue transmitting retransmissions 420 in corresponding slots 405 until the receiving wireless device is able to successfully decode the codeword included in the initial transmission 410.

Each of the retransmissions 420 may be transmitted via the corresponding slots 405 (e.g., retransmission 420-a via the slot 405-b, retransmission 420-b via the slot 405-c, and retransmission 420-c via the slot 405-d) independently of the first polar code. That is, the transmitting wireless device may transmit the information bits in each retransmission 420 without encoding the subset of the information bits using the same first polar code used to encode the codeword for the initial transmission 410.

The transmitting wireless device may identify the subset of information bits to include in each retransmission without receiving feedback from the receiving wireless device identifying the subset of information bits (e.g., the feedback may not specify indexes associated with each information bit in the subset). Instead, the transmitting wireless device may identify each information bit in the subset based on an order of likelihood of error associated with a set of bit-channels used to encode each of the information bits to generate the codeword for the initial transmission 410. For example, the retransmission 420-a may include a first quantity of the information bits (e.g., excluding frozen bits) associated with the highest likelihoods of error. Additionally, the transmitting wireless device may select the information bits to include in the second retransmission 420-b based on the order of the likelihood of error associated with the bit-channels and the information bits included in the previous retransmission 420-a. For example, if the retransmission 420-a includes the X information bits each corresponding to one of the X bit-channels having the highest likelihood of error, the retransmission 420-b may include the next Y information bits (e.g., different than the first X information bits) each corresponding to the next Y bit-channels having the highest likelihood of error (e.g., after the first X bit-channels).

In some cases, an effective MCS associated with the codeword included in the initial transmission 410 may decrease after each retransmission 420. For example, if the initial transmission 410 includes a codeword that is encoded using an MCS 27, the first retransmission 420-a may decrease the effective MCS associated with the codeword to an MCS 26 if the quantity of information bits included in the retransmission 420-a corresponds to a delta between MCS 26 and MCS 27. Additionally, the second retransmission 420-b may decrease the effective MCS associated with the codeword to an MCS 25 if the quantity of information bits included in the retransmission 420-b corresponds to a delta between MCS 25 and MCS 26; and a third retransmission 420-c may decrease the effective MCS associated with the codeword to an MCS 24 if the quantity of information bits included in the retransmission 420-c corresponds to a delta between MCS 24 and MCS 25.

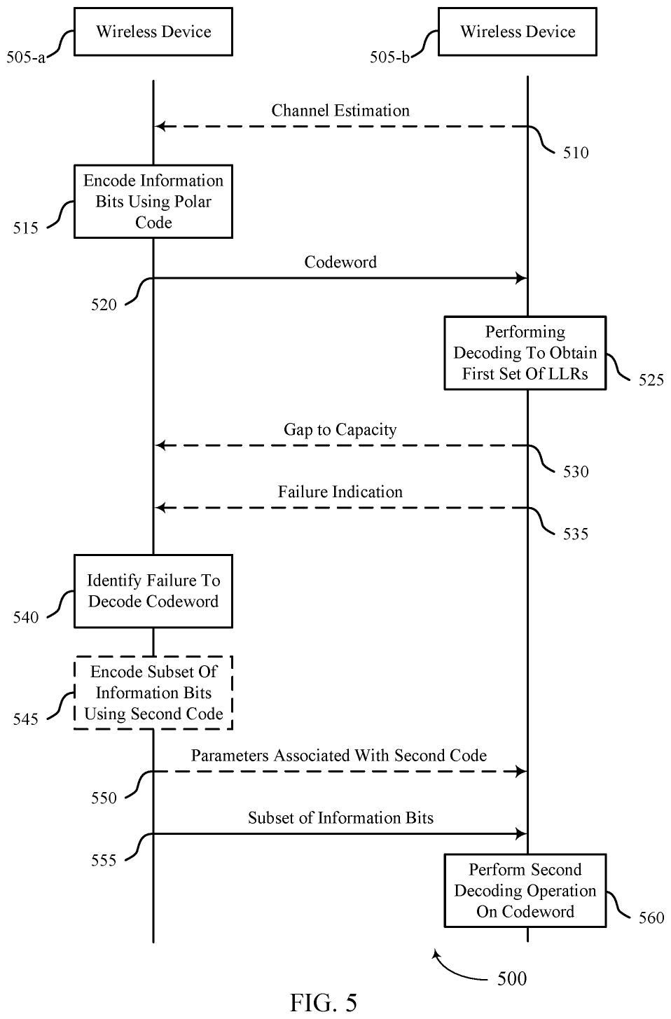

FIG. 5 illustrates an example of a process flow 500 that supports rateless polar codes in accordance with one or more aspects of the present disclosure. The process flow 500 may implement, or be implemented by, aspects of the wireless communications system 100, wireless communications system 200, encoding scheme 300, or retransmission scheme 400. For example, if the wireless device 505-a determines that the wireless device 505-b fails to decode an initial transmission of a polar-encoded codeword, the wireless device 505-a may retransmit a subset of information bits (e.g., included in the codeword) independently of the polar code.

At 510, the wireless device 505-b may optionally transmit signaling indicating a channel estimation. For example, the wireless device 505-b may perform a channel estimation (e.g., based on a CSI-RS) of a channel between the wireless devices 505-a and 505-b, and transmit signaling to the wireless device 505-a indicating the channel estimation.

At 515, the wireless device 505-a may encode information bits using a polar code. For example, the wireless device 505-a may generate a codeword corresponding to a set of information bits using the polar code.

At 520, the wireless device 505-a may transmit, via the channel between the wireless devices 505-a and 505-b, the codeword.

At 525, the wireless device 505-b may perform a decoding operation on the codeword to obtain a first set of LLRs each associated with one of the set of information bits. In the example of the process flow 500, the wireless device 505-b may fail to decode one or more of the set of information bits based on performing the decoding operation at 525. For example, an error check such as a CRC error check may fail for the decoded information bits.

At 530, the wireless device 505-b may optionally transmit signaling indicating a gap to capacity associated with the channel between the wireless devices 505. For example, the wireless device 505-b may transmit signaling indicating a difference between a capacity of the channel and a rate of the codeword transmitted over the channel.

At 535, the wireless device 505-b may optionally transmit signaling indicating the failure of the first wireless device to decode the one or more information bits.

At 540, the wireless device 505-a may identify the failure of the wireless device 505-b to decode one or more of the information bits. For example, the wireless device 505-a may identify the failure based on receiving the signaling at 530 indicating the gap to capacity. Additionally, or alternatively, the wireless device 505-a may identify the failure based on receiving the signaling at 535 indicating the failure. Additionally, or alternatively, the wireless device 505-a may identify the failure based on identifying a presence of a gap to capacity. For example, the wireless device 505-a may identify the presence of the gap to capacity based on a capacity of the channel associate with the channel estimation 510 being less than a rate associated with the polar code used to generate the codeword 520. Based on identifying the failure of the wireless device 505-b, the wireless device 505-a may select a subset of information bits to retransmit to the wireless device 505-b according to an order of likelihood of error associated with a set of bit-channels used for encoding the set of information bits according to the polar code (e.g., at 515).

At 545, the wireless device 505-a may optionally encode the subset of the information bits using a second code that is different from the polar code. In cases that the wireless device 505-a encodes the subset of information bits at 545, at 550 the wireless device 505-a may additionally transmit signaling to the wireless device 505-b indicating one or more parameters associated with the second code (e.g., a quantity of information bits in the subset, a rate of the second code).

At 555, the wireless device 505-a may transmit the subset of information bits to the wireless device 505-b. The wireless device 505-b may obtain a second set of LLRs each corresponding to the subset of the information bits. For example, the wireless device 505-b may obtain the second set of LLRs based on perform decoding (e.g., if the subset of information bits are encoded using a second code), or directly from the transmitted subset of information bits (e.g., if not encoded). The wireless device 505-b may identify an index associated with each information bit in the subset based on an order of the likelihood of error associated with the set of bit-channels used for decoding the codeword using the polar code. In cases that the subset of information bits are encoded using a second code (e.g., different from the polar code), the wireless device 505-b may perform a decoding operation to obtain the second set of LLRs.

At 560, the wireless device 505-b may perform a second decoding operation using the polar code and a combination of the first set of LLRs (e.g., obtained at 525) and the second set of LLRs (e.g., obtained at 555). In some cases, the wireless device 505-b may combine the second set of LLRs with a subset of the first set of LLRs to obtain a third set of LLRs, where each LLR in the subset of the first set of LLRs corresponds to an information bit in the subset of the set of information bits, and where performing the second decoding operation is based on the combining.

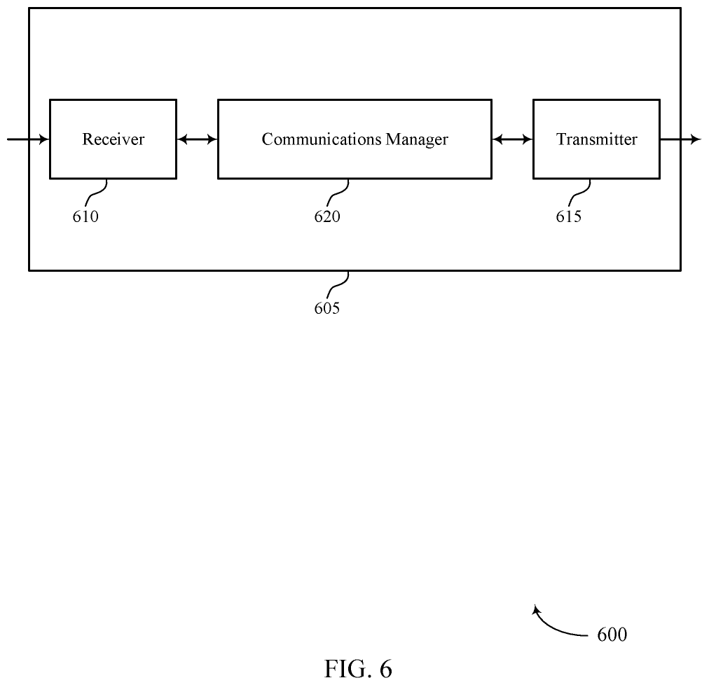

FIG. 6 illustrates a block diagram 600 of a device 605 that supports rateless polar codes in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of rateless polar codes as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first wireless device in accordance with examples as disclosed herein. For example, the communications manager 620 may be configured as or otherwise support a means for transmitting, via a channel between the first wireless device and a second wireless device, a codeword corresponding to a set of multiple information bits encoded using a polar code. The communications manager 620 may be configured as or otherwise support a means for transmitting, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing and more efficient utilization of communication resources.

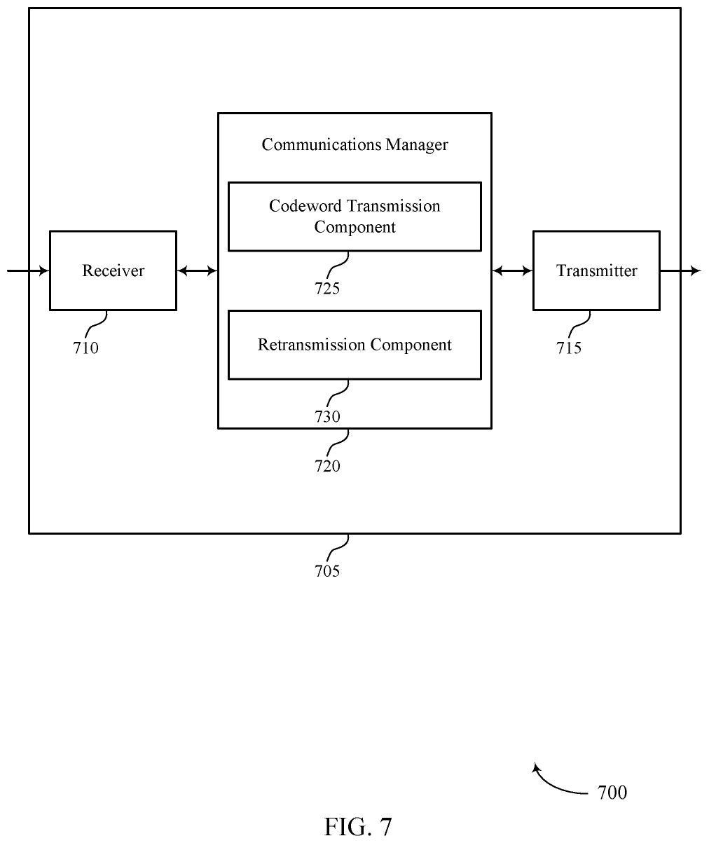

FIG. 7 illustrates a block diagram 700 of a device 705 that supports rateless polar codes in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of rateless polar codes as described herein. For example, the communications manager 720 may include a codeword transmission component 725 a retransmission component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first wireless device in accordance with examples as disclosed herein. The codeword transmission component 725 may be configured as or otherwise support a means for transmitting, via a channel between the first wireless device and a second wireless device, a codeword corresponding to a set of multiple information bits encoded using a polar code. The retransmission component 730 may be configured as or otherwise support a means for transmitting, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

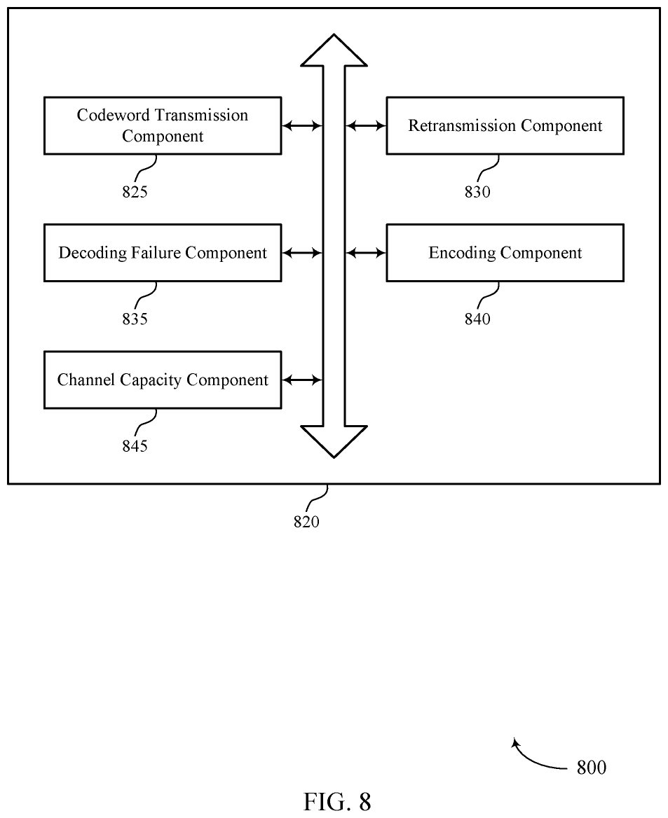

FIG. 8 illustrates a block diagram 800 of a communications manager 820 that supports rateless polar codes in accordance with one or more aspects of the present disclosure. The communications manager 820 may be an example of aspects of a communications manager 620, a communications manager 720, or both, as described herein. The communications manager 820, or various components thereof, may be an example of means for performing various aspects of rateless polar codes as described herein. For example, the communications manager 820 may include a codeword transmission component 825, a retransmission component 830, a decoding failure component 835, an encoding component 840, a channel capacity component 845, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication at a first wireless device in accordance with examples as disclosed herein. The codeword transmission component 825 may be configured as or otherwise support a means for transmitting, via a channel between the first wireless device and a second wireless device, a codeword corresponding to a set of multiple information bits encoded using a polar code. The retransmission component 830 may be configured as or otherwise support a means for transmitting, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

In some examples, the decoding failure component 835 may be configured as or otherwise support a means for receiving, from the second wireless device, signaling indicating the failure of the second wireless device to decode the one or more information bits, where identifying the failure is based on receiving the signaling.

In some examples, identifying the failure is based at least in part on identifying that a capacity of the channel is less than a rate of the codeword transmitted over the channel.

In some examples, the channel capacity component 845 may be configured as or otherwise support a means for receiving, from the second wireless device, signaling indicating a difference between the capacity of the channel and the rate of the codeword, where identifying the failure is based on receiving the signaling.

In some examples, the channel capacity component 845 may be configured as or otherwise support a means for receiving, from the second wireless device, signaling indicating an estimation of the channel, where identifying the failure is based on the capacity of the channel corresponding to the estimation of the channel being less than the rate of the codeword.

In some examples, the encoding component 840 may be configured as or otherwise support a means for encoding the subset of the set of multiple information bits using a second code that is different from the polar code to generate a second codeword, where transmitting the subset of the set of multiple information bits further includes transmitting the second codeword.

In some examples, the encoding component 840 may be configured as or otherwise support a means for transmitting, to the first wireless device, signaling indicating one or more parameters associated with the second code, where transmitting the second codeword is based on transmitting the signaling.

In some examples, the one or more parameters include a quantity of information bits associated with the second code, a rate of the second code, or both.

In some examples, each of the subset of the set of multiple information bits are encoded using the polar code with a respective subset of the set of multiple bit-channels. In some examples, each of the subset of the set of multiple bit-channels are associated with a higher likelihood of error than a second subset of the set of multiple bit-channels that is disjoint from the subset of the set of multiple bit-channels.

In some examples, the retransmission component 830 may be configured as or otherwise support a means for transmitting, after transmitting the subset of the set of multiple information bits and independently of the polar code, a second subset of the set of multiple information bits based on identifying a second failure of the second wireless device to decode one or more information bits of the set of multiple information bits, where the second subset of the set of multiple information bits are selected based on the order of the likelihood of error, the subset of the set of multiple information bits, or a combination thereof.

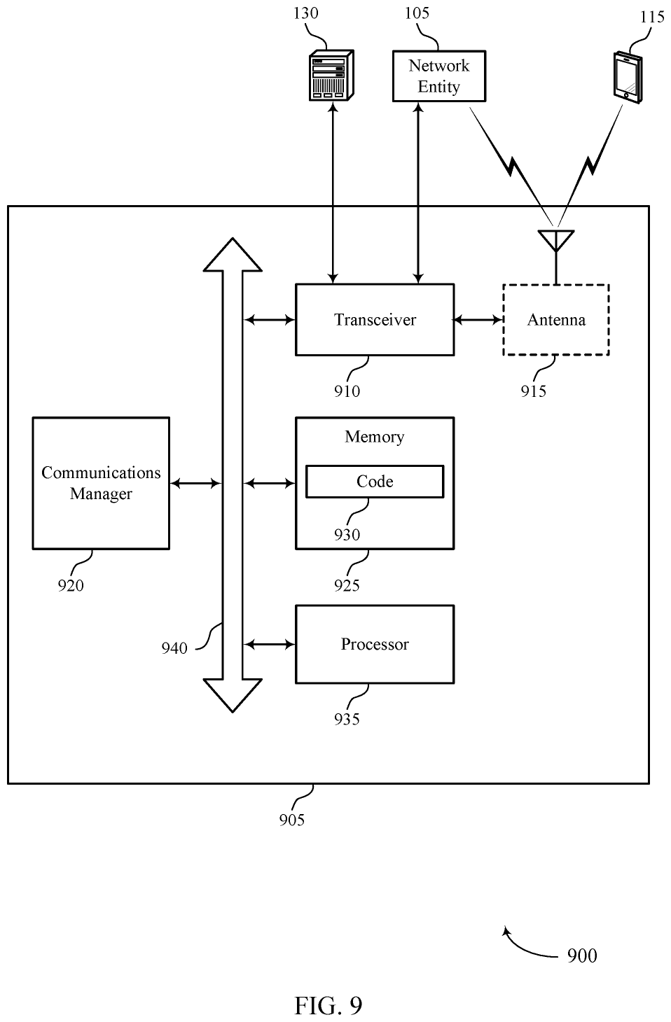

FIG. 9 illustrates a diagram of a system 900 including a device 905 that supports rateless polar codes in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting rateless polar codes). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communication at a first wireless device in accordance with examples as disclosed herein. For example, the communications manager 920 may be configured as or otherwise support a means for transmitting, via a channel between the first wireless device and a second wireless device, a codeword corresponding to a set of multiple information bits encoded using a polar code. The communications manager 920 may be configured as or otherwise support a means for transmitting, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code.

By including or configuring the communications manager 920 in accordance with examples as described herein, the device 905 may support techniques for reduced latency, more efficient utilization of communication resources, and improved coordination between devices.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, the processor 935, the memory 925, the code 930, or any combination thereof. For example, the code 930 may include instructions executable by the processor 935 to cause the device 905 to perform various aspects of rateless polar codes as described herein, or the processor 935 and the memory 925 may be otherwise configured to perform or support such operations.

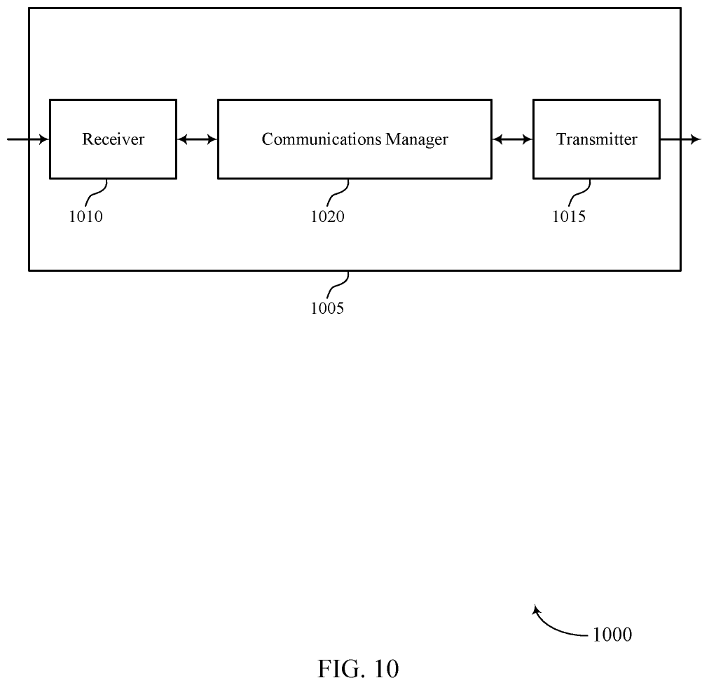

FIG. 10 illustrates a block diagram 1000 of a device 1005 that supports rateless polar codes in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to rateless polar codes). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to rateless polar codes). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of rateless polar codes as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first wireless device in accordance with examples as disclosed herein. For example, the communications manager 1020 may be configured as or otherwise support a means for receiving, via a channel between the first wireless device and a second wireless device, a codeword corresponding to a set of multiple information bits. The communications manager 1020 may be configured as or otherwise support a means for obtaining a first set of multiple LLRs associated with the set of multiple information bits based on performing a first decoding operation on the codeword using a polar code. The communications manager 1020 may be configured as or otherwise support a means for receiving, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code. The communications manager 1020 may be configured as or otherwise support a means for performing, on the codeword, a second decoding operation using the polar code and a combination of the first set of multiple LLRs and the second set of multiple LLRs.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, and more efficient utilization of communication resources.

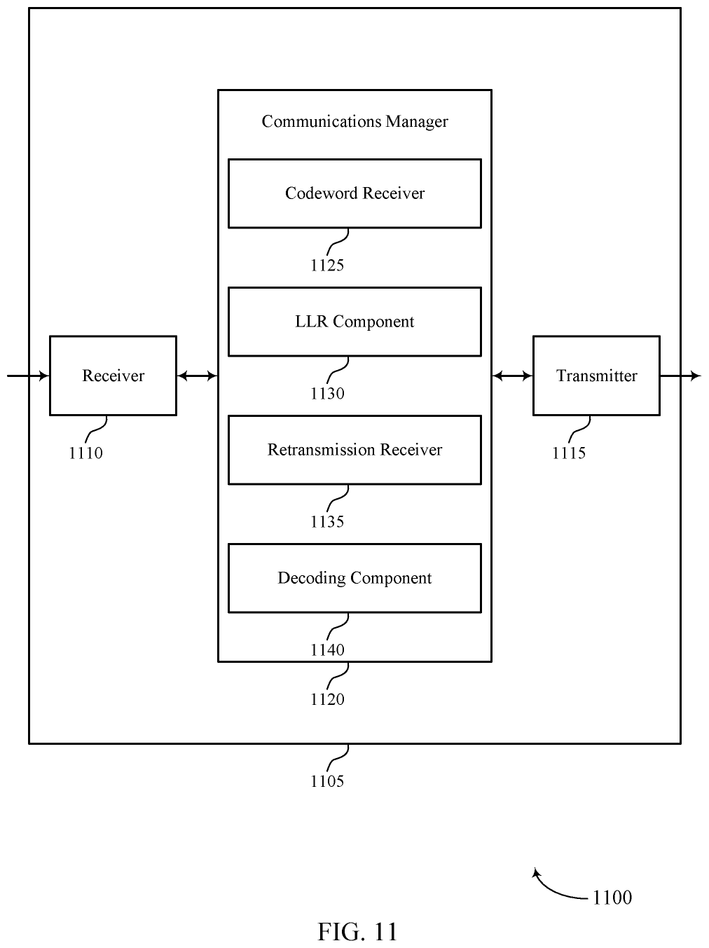

FIG. 11 illustrates a block diagram 1100 of a device 1105 that supports rateless polar codes in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to rateless polar codes). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to rateless polar codes). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of rateless polar codes as described herein. For example, the communications manager 1120 may include a codeword receiver 1125, an LLR component 1130, a retransmission receiver 1135, a decoding component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first wireless device in accordance with examples as disclosed herein. The codeword receiver 1125 may be configured as or otherwise support a means for receiving, via a channel between the first wireless device and a second wireless device, a codeword corresponding to a set of multiple information bits. The LLR component 1130 may be configured as or otherwise support a means for obtaining a first set of multiple LLRs associated with the set of multiple information bits based on performing a first decoding operation on the codeword using a polar code. The retransmission receiver 1135 may be configured as or otherwise support a means for receiving, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code. The decoding component 1140 may be configured as or otherwise support a means for performing, on the codeword, a second decoding operation using the polar code and a combination of the first set of multiple LLRs and the second set of multiple LLRs.

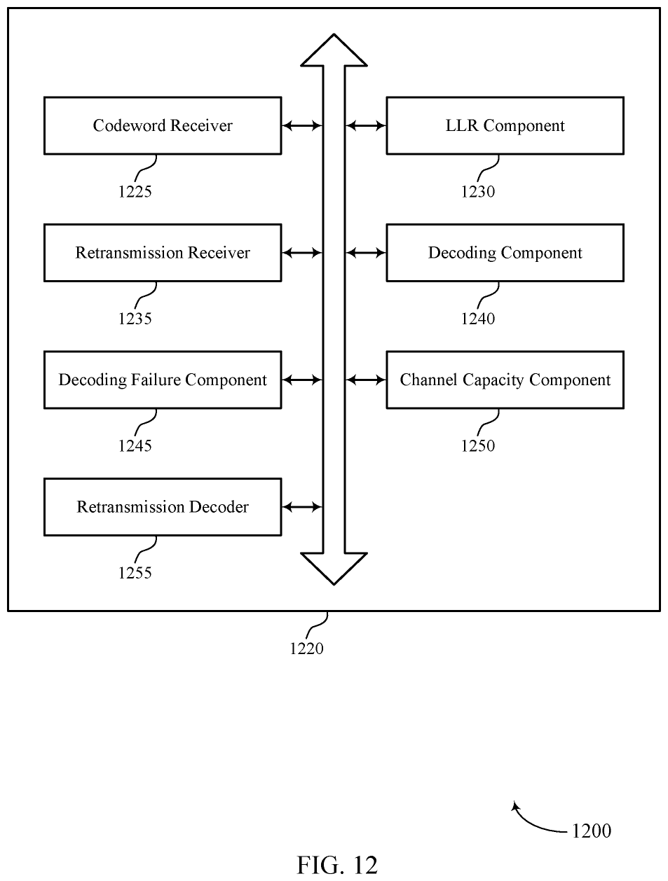

FIG. 12 illustrates a block diagram 1200 of a communications manager 1220 that supports rateless polar codes in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of rateless polar codes as described herein. For example, the communications manager 1220 may include a codeword receiver 1225, an LLR component 1230, a retransmission receiver 1235, a decoding component 1240, a decoding failure component 1245, a channel capacity component 1250, a retransmission decoder 1255, or any combination thereof. Each of these components may communicate, directly or indirectly, with one another (e.g., via one or more buses).

The communications manager 1220 may support wireless communication at a first wireless device in accordance with examples as disclosed herein. The codeword receiver 1225 may be configured as or otherwise support a means for receiving, via a channel between the first wireless device and a second wireless device, a codeword corresponding to a set of multiple information bits. The LLR component 1230 may be configured as or otherwise support a means for obtaining a first set of multiple LLRs associated with the set of multiple information bits based on performing a first decoding operation on the codeword using a polar code. The retransmission receiver 1235 may be configured as or otherwise support a means for receiving, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code. The decoding component 1240 may be configured as or otherwise support a means for performing, on the codeword, a second decoding operation using the polar code and a combination of the first set of multiple LLRs and the second set of multiple LLRs.

In some examples, the decoding failure component 1245 may be configured as or otherwise support a means for transmitting, to the second wireless device, signaling indicating the failure of the first wireless device to decode the one or more information bits, where receiving the second set of multiple LLRs is based on transmitting the signaling.

In some examples, the channel capacity component 1250 may be configured as or otherwise support a means for transmitting, to the second wireless device, signaling indicating a difference between a capacity of the channel and a rate of the codeword transmitted over the channel, where receiving the second set of multiple LLRs is based on transmitting the signaling.

In some examples, the channel capacity component 1250 may be configured as or otherwise support a means for transmitting, to the second wireless device, signaling indicating an estimation of the channel, where receiving the second set of multiple LLRs is based on transmitting the signaling.

In some examples, the retransmission decoder 1255 may be configured as or otherwise support a means for decoding, using a second code that is different from the polar code, a second codeword to obtain the second set of multiple LLRs, where receiving the second set of multiple LLRs further includes receiving the second codeword.

In some examples, the retransmission decoder 1255 may be configured as or otherwise support a means for receiving, from the second wireless device, signaling indicating one or more parameters associated with the second code, where receiving the second codeword is based on receiving the signaling.

In some examples, the one or more parameters include a quantity of information bits associated with the second code, a rate of the second code, or both.

In some examples, the LLR component 1230 may be configured as or otherwise support a means for combining the second set of multiple LLRs with a subset of the first set of multiple LLRs to obtain a third set of multiple LLRs, where each LLR in the subset of the first set of multiple LLRs corresponds to an information bit in the subset of the set of multiple information bits, and where performing the second decoding operation is based on the combining.

In some examples, performing the second decoding operation is based on a first sign of at least one LLR in the third set of multiple LLRs being different from a second sign of at least one corresponding LLR in the subset of the first set of multiple LLRs.

In some examples, the decoding component 1240 may be configured as or otherwise support a means for refraining from performing the second decoding operation on one or more bits of the codeword based on signs of one or more LLRs in the third set of multiple LLRs being the same as signs of one or more corresponding LLRs in the subset of the first set of multiple LLRs. In some examples, the decoding component 1240 may be configured as or otherwise support a means for initiating the second decoding operation based on the first sign of the at least one LLR in the third set of multiple LLRs being different from the second sign of the at least one corresponding LLR in the subset of the first set of multiple LLRs.

In some examples, each of the subset of the set of multiple information bits are decoded using the polar code with a respective subset of the set of multiple bit-channels. In some examples, each of the subset of the set of multiple bit-channels are associated with a higher likelihood of error than a second subset of the set of multiple bit-channels that is disjoint from the subset of the set of multiple bit-channels.

In some examples, the retransmission receiver 1235 may be configured as or otherwise support a means for receiving, after receiving the subset of the set of multiple information bits and based on a second failure of the first wireless device to decode one or more information bits of the set of multiple information bits, a second subset of the set of multiple information bits corresponding to a respective third set of multiple LLRs that are independent of the polar code, where a second index associated with each information bit in the second subset of the set of multiple information bits is identified based on the order of the likelihood of error, the subset of the set of multiple information bits, or a combination thereof.

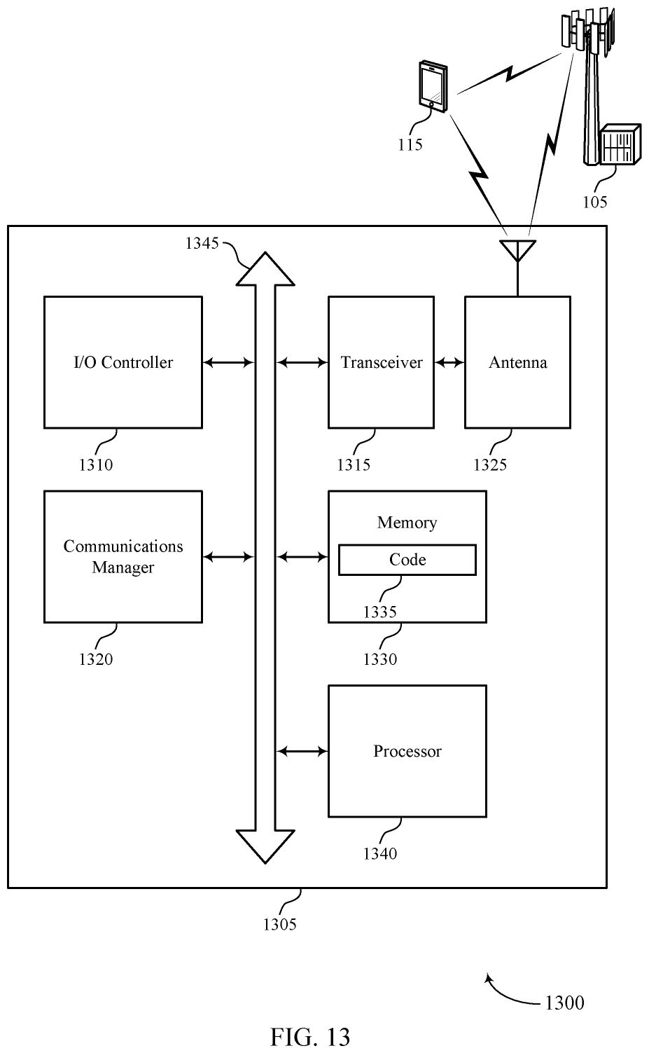

FIG. 13 illustrates a diagram of a system 1300 including a device 1305 that supports rateless polar codes in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting rateless polar codes). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a first wireless device in accordance with examples as disclosed herein. For example, the communications manager 1320 may be configured as or otherwise support a means for receiving, via a channel between the first wireless device and a second wireless device, a codeword corresponding to a set of multiple information bits. The communications manager 1320 may be configured as or otherwise support a means for obtaining a first set of multiple LLRs associated with the set of multiple information bits based on performing a first decoding operation on the codeword using a polar code. The communications manager 1320 may be configured as or otherwise support a means for receiving, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code. The communications manager 1320 may be configured as or otherwise support a means for performing, on the codeword, a second decoding operation using the polar code and a combination of the first set of multiple LLRs and the second set of multiple LLRs.

By including or configuring the communications manager 1320 in accordance with examples as described herein, the device 1305 may support techniques for reduced latency, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of rateless polar codes as described herein, or the processor 1340 and the memory 1330 may be otherwise configured to perform or support such operations.

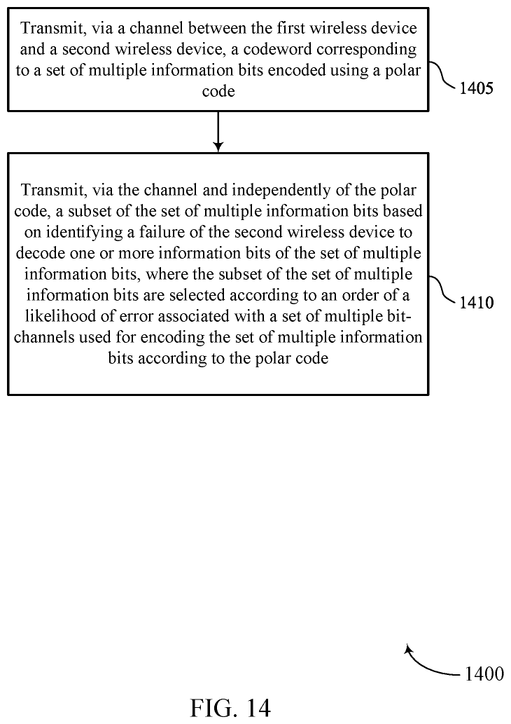

FIG. 14 illustrates a flowchart showing a method 1400 that supports rateless polar codes in accordance with one or more aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, via a channel between the first wireless device and a second wireless device, a codeword corresponding to a set of multiple information bits encoded using a polar code. The operations of 1405 may be performed in accordance with examples as disclosed herein. In some examples, aspects of the operations of 1405 may be performed by a codeword transmission component 825 as described with reference to FIG. 8.

At 1410, the method may include transmitting, via the channel and independently of the polar code, a subset of the set of multiple information bits based on identifying a failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code. The operations of 1410 may be performed in accordance with examples as disclosed herein. In some examples, aspects of the operations of 1410 may be performed by a retransmission component 830 as described with reference to FIG. 8.

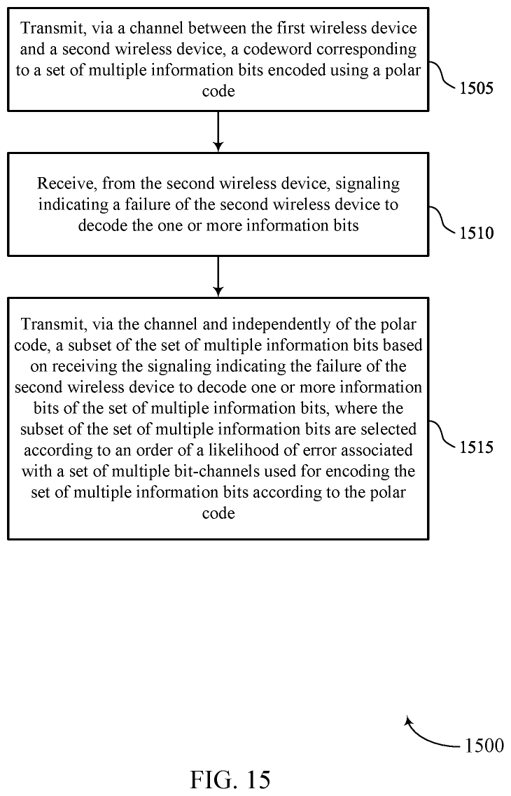

FIG. 15 illustrates a flowchart showing a method 1500 that supports rateless polar codes in accordance with one or more aspects of the present disclosure. The operations of the method 1500 may be implemented by a network entity or its components as described herein. For example, the operations of the method 1500 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, via a channel between the first wireless device and a second wireless device, a codeword corresponding to a set of multiple information bits encoded using a polar code. The operations of 1505 may be performed in accordance with examples as disclosed herein. In some examples, aspects of the operations of 1505 may be performed by a codeword transmission component 825 as described with reference to FIG. 8.

At 1510, the method may include receiving, from the second wireless device, signaling indicating the failure of the second wireless device to decode the one or more information bits. The operations of 1510 may be performed in accordance with examples as disclosed herein. In some examples, aspects of the operations of 1510 may be performed by a decoding failure component 835 as described with reference to FIG. 8.

At 1515, the method may include transmitting, via the channel and independently of the polar code, a subset of the set of multiple information bits based on receiving the signaling indicating the failure of the second wireless device to decode one or more information bits of the set of multiple information bits, where the subset of the set of multiple information bits are selected according to an order of a likelihood of error associated with a set of multiple bit-channels used for encoding the set of multiple information bits according to the polar code. The operations of 1515 may be performed in accordance with examples as disclosed herein. In some examples, aspects of the operations of 1515 may be performed by a retransmission component 830 as described with reference to FIG. 8.

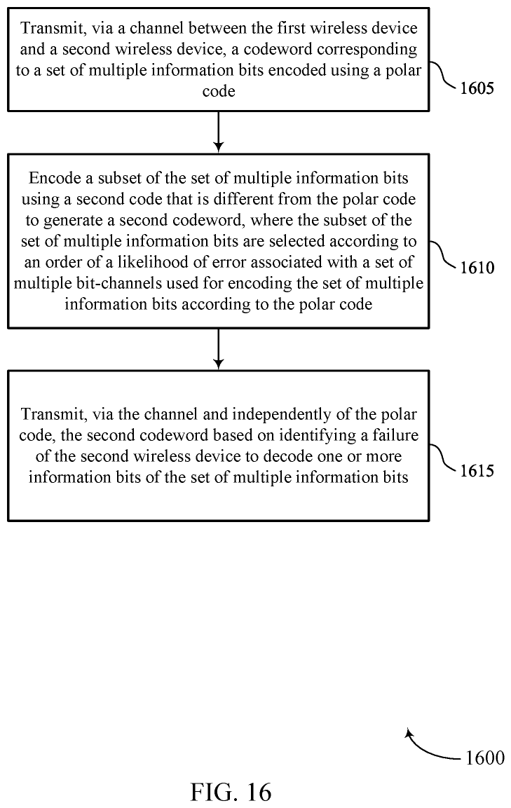

FIG. 16 illustrates a flowchart showing a method 1600 that supports rateless polar codes in accordance with one or more aspects of the present disclosure. The operations of the method 1600 may be implemented by a network entity or its components as described herein. For example, the operations of the method 1600 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, via a channel between the first wireless device and a second wireless device, a codeword corresponding to a set of multiple information bits encoded using a polar code. The operations of 1605 may be performed in accordance with examples as disclosed herein. In some examples, aspects of the operations of 1605 may be performed by a codeword transmission component 825 as described with reference to FIG. 8.

At 1610, the method may include encoding a subset of the set of multiple information bits using a second code that is different from the polar code to generate a second codeword, where the subset of the set of multiple information bits are selected according to an order of a likelihood of error associated with a set of multiple bit-channels used for encoding the set of multiple information bits according to the polar code. The operations of 1610 may be performed in accordance with examples as disclosed herein. In some examples, aspects of the operations of 1610 may be performed by an encoding component 840 as described with reference to FIG. 8.

At 1615, the method may include transmitting, via the channel and independently of the polar code, the second codeword based on identifying a failure of the second wireless device to decode one or more information bits of the set of multiple information bits. The operations of 1615 may be performed in accordance with examples as disclosed herein. In some examples, aspects of the operations of 1615 may be performed by a retransmission component 830 as described with reference to FIG. 8.

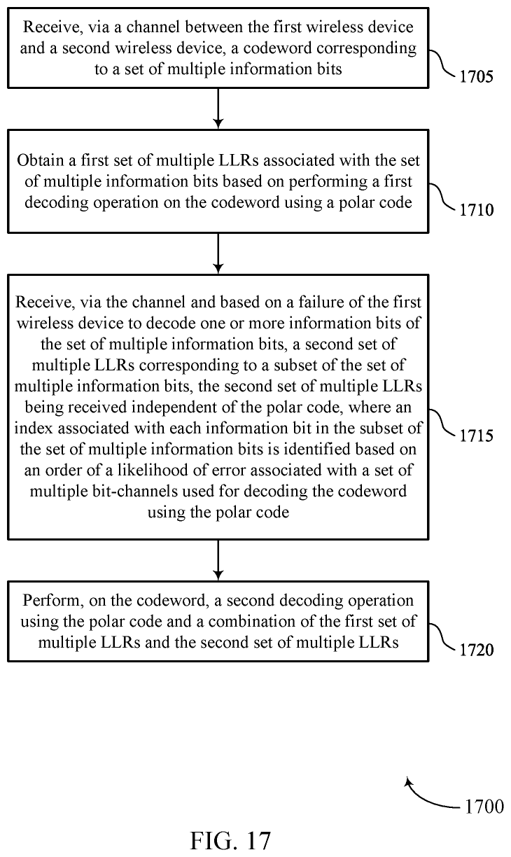

FIG. 17 illustrates a flowchart showing a method 1700 that supports rateless polar codes in accordance with one or more aspects of the present disclosure. The operations of the method 1700 may be implemented by a UE or its components as described herein. For example, the operations of the method 1700 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1705, the method may include receiving, via a channel between the first wireless device and a second wireless device, a codeword corresponding to a set of multiple information bits. The operations of 1705 may be performed in accordance with examples as disclosed herein. In some examples, aspects of the operations of 1705 may be performed by a codeword receiver 1225 as described with reference to FIG. 12.

At 1710, the method may include obtaining a first set of multiple LLRs associated with the set of multiple information bits based on performing a first decoding operation on the codeword using a polar code. The operations of 1710 may be performed in accordance with examples as disclosed herein. In some examples, aspects of the operations of 1710 may be performed by an LLR component 1230 as described with reference to FIG. 12.

At 1715, the method may include receiving, via the channel and based on a failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code. The operations of 1715 may be performed in accordance with examples as disclosed herein. In some examples, aspects of the operations of 1715 may be performed by a retransmission receiver 1235 as described with reference to FIG. 12.

At 1720, the method may include performing, on the codeword, a second decoding operation using the polar code and a combination of the first set of multiple LLRs and the second set of multiple LLRs. The operations of 1720 may be performed in accordance with examples as disclosed herein. In some examples, aspects of the operations of 1720 may be performed by a decoding component 1240 as described with reference to FIG. 12.

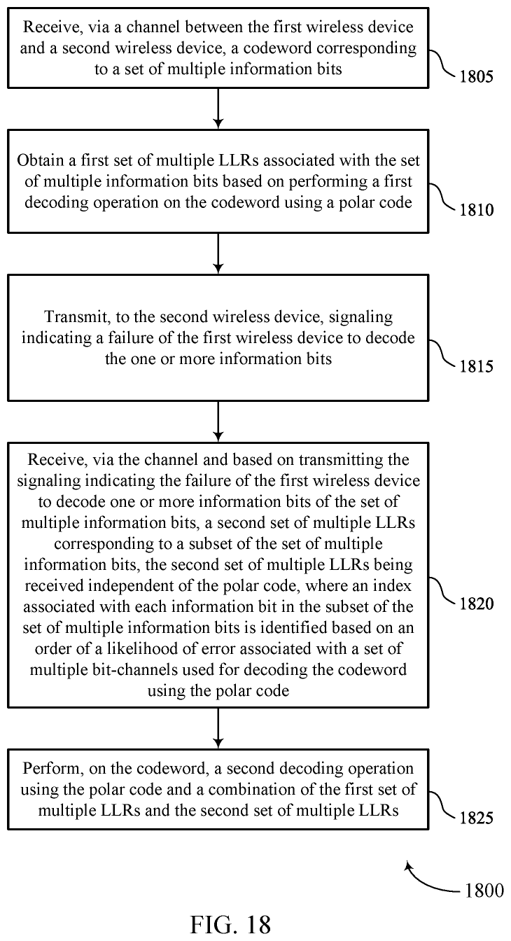

FIG. 18 illustrates a flowchart showing a method 1800 that supports rateless polar codes in accordance with one or more aspects of the present disclosure. The operations of the method 1800 may be implemented by a UE or its components as described herein. For example, the operations of the method 1800 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1805, the method may include receiving, via a channel between the first wireless device and a second wireless device, a codeword corresponding to a set of multiple information bits. The operations of 1805 may be performed in accordance with examples as disclosed herein. In some examples, aspects of the operations of 1805 may be performed by a codeword receiver 1225 as described with reference to FIG. 12.

At 1810, the method may include obtaining a first set of multiple LLRs associated with the set of multiple information bits based on performing a first decoding operation on the codeword using a polar code. The operations of 1810 may be performed in accordance with examples as disclosed herein. In some examples, aspects of the operations of 1810 may be performed by an LLR component 1230 as described with reference to FIG. 12.

At 1815, the method may include transmitting, to the second wireless device, signaling indicating a failure of the first wireless device to decode the one or more information bits. The operations of 1815 may be performed in accordance with examples as disclosed herein. In some examples, aspects of the operations of 1815 may be performed by a decoding failure component 1245 as described with reference to FIG. 12.

At 1820, the method may include receiving, via the channel and based on transmitting the signaling indicating the failure of the first wireless device to decode one or more information bits of the set of multiple information bits, a second set of multiple LLRs corresponding to a subset of the set of multiple information bits, the second set of multiple LLRs being received independent of the polar code, where an index associated with each information bit in the subset of the set of multiple information bits is identified based on an order of a likelihood of error associated with a set of multiple bit-channels used for decoding the codeword using the polar code. The operations of 1820 may be performed in accordance with examples as disclosed herein. In some examples, aspects of the operations of 1820 may be performed by a retransmission receiver 1235 as described with reference to FIG. 12.

At 1825, the method may include performing, on the codeword, a second decoding operation using the polar code and a combination of the first set of multiple LLRs and the second set of multiple LLRs. The operations of 1825 may be performed in accordance with examples as disclosed herein. In some examples, aspects of the operations of 1825 may be performed by a decoding component 1240 as described with reference to FIG. 12.

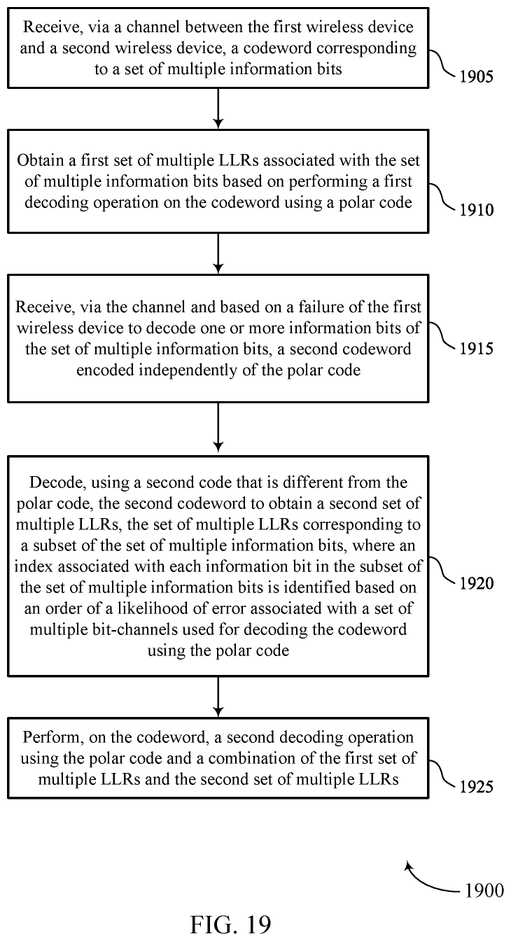

FIG. 19 illustrates a flowchart showing a method 1900 that supports rateless polar codes in accordance with one or more aspects of the present disclosure. The operations of the method 1900 may be implemented by a UE or its components as described herein. For example, the operations of the method 1900 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1905, the method may include receiving, via a channel between the first wireless device and a second wireless device, a codeword corresponding to a set of multiple information bits. The operations of 1905 may be performed in accordance with examples as disclosed herein. In some examples, aspects of the operations of 1905 may be performed by a codeword receiver 1225 as described with reference to FIG. 12.

At 1910, the method may include obtaining a first set of multiple LLRs associated with the set of multiple information bits based on performing a first decoding operation on the codeword using a polar code. The operations of 1910 may be performed in accordance with examples as disclosed herein. In some examples, aspects of the operations of 1910 may be performed by an LLR component 1230 as described with reference to FIG. 12.

At 1915, the method may include receiving, via the channel and based on a failure of the first wireless device to decode one or more information bits of the set of multiple information bits, a second codeword encoded independently of the polar code. The operations of 1915 may be performed in accordance with examples as disclosed herein. In some examples, aspects of the operations of 1915 may be performed by a retransmission receiver 1235 as described with reference to FIG. 12.

At 1920, the method may include decoding, using a second code that is different from the polar code, the second codeword to obtain a second set of multiple LLRs, where the second set of multiple LLRs correspond to a subset of the set of multiple information bits, the second set of multiple LLRs being received independent of the polar code, and where an index associated with each information bit in the subset of the set of multiple information bits is identified based on an order of a likelihood of error associated with a set of multiple bit-channels used for decoding the codeword using the polar code. The operations of 1920 may be performed in accordance with examples as disclosed herein. In some examples, aspects of the operations of 1920 may be performed by a retransmission decoder 1255 as described with reference to FIG. 12.

At 1925, the method may include performing, on the codeword, a second decoding operation using the polar code and a combination of the first set of multiple LLRs and the second set of multiple LLRs. The operations of 1925 may be performed in accordance with examples as disclosed herein. In some examples, aspects of the operations of 1925 may be performed by a decoding component 1240 as described with reference to FIG. 12.
Aspect 1: A method for wireless communication at a first wireless device, comprising: transmitting, via a channel between the first wireless device and a second wireless device, a codeword corresponding to a plurality of information bits encoded using a polar code; and transmitting, via the channel and independently of the polar code, a subset of the plurality of information bits based at least in part on identifying a failure of the second wireless device to decode one or more information bits of the plurality of information bits, wherein the subset of the plurality of information bits are selected according to an order of a likelihood of error associated with a plurality of bit-channels used for encoding the plurality of information bits according to the polar code.
Aspect 2: The method of aspect 1, further comprising: receiving, from the second wireless device, signaling indicating the failure of the second wireless device to decode the one or more information bits, wherein identifying the failure is based at least in part on receiving the signaling.
Aspect 3: The method of any of aspects 1 through 2, wherein identifying the failure is based at least in part on identifying that a capacity of the channel is less than a rate of the codeword transmitted over the channel.
Aspect 4: The method of aspect 3, further comprising: receiving, from the second wireless device, signaling indicating a difference between the capacity of the channel and the rate of the codeword, wherein identifying the failure is based at least in part on receiving the signaling.
Aspect 5: The method of any of aspects 3 through 4, further comprising: receiving, from the second wireless device, signaling indicating an estimation of the channel, wherein identifying the failure is based at least in part on the capacity of the channel corresponding to the estimation of the channel being less than the rate of the codeword.
Aspect 6: The method of any of aspects 1 through 5, further comprising: encoding the subset of the plurality of information bits using a second code that is different from the polar code to generate a second codeword, wherein transmitting the subset of the plurality of information bits further comprises transmitting the second codeword.
Aspect 7: The method of aspect 6, further comprising: transmitting, to the first wireless device, signaling indicating one or more parameters associated with the second code, wherein transmitting the second codeword is based at least in part on transmitting the signaling.
Aspect 8: The method of any of aspects 6 through 7, wherein the one or more parameters comprise a quantity of information bits associated with the second code, a rate of the second code, or both.
Aspect 9: The method of any of aspects 1 through 8, wherein each of the subset of the plurality of information bits are encoded using the polar code with a respective subset of the plurality of bit-channels; and each of the subset of the plurality of bit-channels are associated with a higher likelihood of error than a second subset of the plurality of bit-channels that is disjoint from the subset of the plurality of bit-channels.
Aspect 10: The method of any of aspects 1 through 9, further comprising: transmitting, after transmitting the subset of the plurality of information bits and independently of the polar code, a second subset of the plurality of information bits based at least in part on identifying a second failure of the second wireless device to decode one or more information bits of the plurality of information bits, wherein the second subset of the plurality of information bits are selected based at least in part on the order of the likelihood of error, the subset of the plurality of information bits, or a combination thereof.
Aspect 11: A method for wireless communication at a first wireless device, comprising: receiving, via a channel between the first wireless device and a second wireless device, a codeword corresponding to a plurality of information bits; obtaining a first plurality of log likelihood ratios (LLRs) associated with the plurality of information bits based at least in part on performing a first decoding operation on the codeword using a polar code; receiving, via the channel and based at least in part on a failure of the first wireless device to decode one or more information bits of the plurality of information bits, a second plurality of LLRs corresponding to a subset of the plurality of information bits, the second plurality of LLRs being received independent of the polar code, wherein an index associated with each information bit in the subset of the plurality of information bits is identified based at least in part on an order of a likelihood of error associated with a plurality of bit-channels used for decoding the codeword using the polar code; and performing, on the codeword, a second decoding operation using the polar code and a combination of the first plurality of LLRs and the second plurality of LLRs.
Aspect 12: The method of aspect 11, further comprising: transmitting, to the second wireless device, signaling indicating the failure of the first wireless device to decode the one or more information bits, wherein receiving the second plurality of LLRs is based at least in part on transmitting the signaling.
Aspect 13: The method of any of aspects 11 through 12, further comprising: transmitting, to the second wireless device, signaling indicating a difference between a capacity of the channel and a rate of the codeword transmitted over the channel, wherein receiving the second plurality of LLRs is based at least in part on transmitting the signaling.
Aspect 14: The method of any of aspects 11 through 13, further comprising: transmitting, to the second wireless device, signaling indicating an estimation of the channel, wherein receiving the second plurality of LLRs is based at least in part on transmitting the signaling.
Aspect 15: The method of any of aspects 11 through 14, further comprising: decoding, using a second code that is different from the polar code, a second codeword to obtain the second plurality of LLRs, wherein receiving the second plurality of LLRs further comprises receiving the second codeword.
Aspect 16: The method of aspect 15, further comprising: receiving, from the second wireless device, signaling indicating one or more parameters associated with the second code, wherein receiving the second codeword is based at least in part on receiving the signaling.
Aspect 17: The method of any of aspects 15 through 16, wherein the one or more parameters comprise a quantity of information bits associated with the second code, a rate of the second code, or both.
Aspect 18: The method of any of aspects 11 through 17, further comprising: combining the second plurality of LLRs with a subset of the first plurality of LLRs to obtain a third plurality of LLRs, wherein each LLR in the subset of the first plurality of LLRs corresponds to an information bit in the subset of the plurality of information bits, and wherein performing the second decoding operation is based at least in part on the combining.
Aspect 19: The method of aspect 18, wherein performing the second decoding operation is based at least in part on a first sign of at least one LLR in the third plurality of LLRs being different from a second sign of at least one corresponding LLR in the subset of the first plurality of LLRs.
Aspect 20: The method of aspect 19, further comprising: refraining from performing the second decoding operation on one or more bits of the codeword based at least in part on signs of one or more LLRs in the third plurality of LLRs being the same as signs of one or more corresponding LLRs in the subset of the first plurality of LLRs; and initiating the second decoding operation based at least in part on the first sign of the at least one LLR in the third plurality of LLRs being different from the second sign of the at least one corresponding LLR in the subset of the first plurality of LLRs.
Aspect 21: The method of any of aspects 11 through 20, wherein each of the subset of the plurality of information bits are decoded using the polar code with a respective subset of the plurality of bit-channels; and each of the subset of the plurality of bit-channels are associated with a higher likelihood of error than a second subset of the plurality of bit-channels that is disjoint from the subset of the plurality of bit-channels.
Aspect 22: The method of any of aspects 11 through 21, further comprising: receiving, after receiving the subset of the plurality of information bits and based at least in part on a second failure of the first wireless device to decode one or more information bits of the plurality of information bits, a second subset of the plurality of information bits corresponding to a respective third plurality of LLRs that are independent of the polar code, wherein a second index associated with each information bit in the second subset of the plurality of information bits is identified based at least in part on the order of the likelihood of error, the subset of the plurality of information bits, or a combination thereof.
Aspect 23: An apparatus for wireless communication at a first wireless device, comprising a processor; memory coupled with the processor; and instructions stored in the memory and executable by the processor to cause the apparatus to perform a method of any of aspects 1 through 10.
Aspect 24: An apparatus for wireless communication at a first wireless device, comprising at least one means for performing a method of any of aspects 1 through 10.
Aspect 25: A non-transitory computer-readable medium storing code for wireless communication at a first wireless device, the code comprising instructions executable by a processor to perform a method of any of aspects 1 through 10.
Aspect 26: An apparatus for wireless communication at a first wireless device, comprising a processor; memory coupled with the processor; and instructions stored in the memory and executable by the processor to cause the apparatus to perform a method of any of aspects 11 through 22.
Aspect 27: An apparatus for wireless communication at a first wireless device, comprising at least one means for performing a method of any of aspects 11 through 22.
Aspect 28: A non-transitory computer-readable medium storing code for wireless communication at a first wireless device, the code comprising instructions executable by a processor to perform a method of any of aspects 11 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first wireless device, comprising:
transmitting, via a channel between the first wireless device and a second wireless device, a codeword corresponding to a plurality of information bits encoded using a polar code; and
transmitting, via the channel and independently of the polar code, a subset of the plurality of information bits based at least in part on identifying a failure of the second wireless device to decode one or more information bits of the plurality of information bits, wherein the subset of the plurality of information bits are selected according to an order of a likelihood of error associated with a plurality of bit-channels used for encoding the plurality of information bits according to the polar code.

2. The method of claim 1, further comprising:
receiving, from the second wireless device, signaling indicating the failure of the second wireless device to decode the one or more information bits, wherein identifying the failure is based at least in part on receiving the signaling.

3. The method of claim 1, wherein identifying the failure is based at least in part on identifying that a capacity of the channel is less than a rate of the codeword transmitted over the channel.

4. The method of claim 3, further comprising:
receiving, from the second wireless device, signaling indicating a difference between the capacity of the channel and the rate of the codeword, wherein identifying the failure is based at least in part on receiving the signaling.

5. The method of claim 3, further comprising:
receiving, from the second wireless device, signaling indicating an estimation of the channel, wherein identifying the failure is based at least in part on the capacity of the channel corresponding to the estimation of the channel being less than the rate of the codeword.

6. The method of claim 1, further comprising:
encoding the subset of the plurality of information bits using a second code that is different from the polar code to generate a second codeword, wherein transmitting the subset of the plurality of information bits further comprises transmitting the second codeword.

7. The method of claim 6, further comprising:
transmitting, to the first wireless device, signaling indicating one or more parameters associated with the second code, wherein transmitting the second codeword is based at least in part on transmitting the signaling.

8. The method of claim 7, wherein the one or more parameters comprise a quantity of information bits associated with the second code, a rate of the second code, or both.

9. The method of claim 1, wherein:
each of the subset of the plurality of information bits are encoded using the polar code with a respective subset of the plurality of bit-channels; and
each of the subset of the plurality of bit-channels are associated with a higher likelihood of error than a second subset of the plurality of bit-channels that is disjoint from the subset of the plurality of bit-channels.

10. The method of claim 1, further comprising:
transmitting, after transmitting the subset of the plurality of information bits and independently of the polar code, a second subset of the plurality of information bits based at least in part on identifying a second failure of the second wireless device to decode one or more information bits of the plurality of information bits, wherein the second subset of the plurality of information bits are selected based at least in part on the order of the likelihood of error, the subset of the plurality of information bits, or a combination thereof.

11. A method for wireless communication at a first wireless device, comprising:
receiving, via a channel between the first wireless device and a second wireless device, a codeword corresponding to a plurality of information bits;
obtaining a first plurality of log likelihood ratios (LLRs) associated with the plurality of information bits based at least in part on performing a first decoding operation on the codeword using a polar code;
receiving, via the channel and based at least in part on a failure of the first wireless device to decode one or more information bits of the plurality of information bits, a second plurality of LLRs corresponding to a subset of the plurality of information bits, the second plurality of LLRs being received independent of the polar code, wherein an index associated with each information bit in the subset of the plurality of information bits is identified based at least in part on an order of a likelihood of error associated with a plurality of bit-channels used for decoding the codeword using the polar code; and
performing, on the codeword, a second decoding operation using the polar code and a combination of the first plurality of LLRs and the second plurality of LLRs.

12. The method of claim 11, further comprising:
transmitting, to the second wireless device, signaling indicating the failure of the first wireless device to decode the one or more information bits, wherein receiving the second plurality of LLRs is based at least in part on transmitting the signaling.

13. The method of claim 11, further comprising:
transmitting, to the second wireless device, signaling indicating a difference between a capacity of the channel and a rate of the codeword transmitted over the channel, wherein receiving the second plurality of LLRs is based at least in part on transmitting the signaling.

14. The method of claim 11, further comprising:
transmitting, to the second wireless device, signaling indicating an estimation of the channel, wherein receiving the second plurality of LLRs is based at least in part on transmitting the signaling.

15. The method of claim 11, further comprising:
decoding, using a second code that is different from the polar code, a second codeword to obtain the second plurality of LLRs, wherein receiving the second plurality of LLRs further comprises receiving the second codeword.

16. The method of claim 15, further comprising:
receiving, from the second wireless device, signaling indicating one or more parameters associated with the second code, wherein receiving the second codeword is based at least in part on receiving the signaling.

17. The method of claim 16, wherein the one or more parameters comprise a quantity of information bits associated with the second code, a rate of the second code, or both.

18. The method of claim 11, further comprising:
combining the second plurality of LLRs with a subset of the first plurality of LLRs to obtain a third plurality of LLRs, wherein each LLR in the subset of the first plurality of LLRs corresponds to an information bit in the subset of the plurality of information bits, and wherein performing the second decoding operation is based at least in part on the combining.

19. The method of claim 18, wherein performing the second decoding operation is based at least in part on a first sign of at least one LLR in the third plurality of LLRs being different from a second sign of at least one corresponding LLR in the subset of the first plurality of LLRs.

20. The method of claim 19, further comprising:
refraining from performing the second decoding operation on one or more bits of the codeword based at least in part on signs of one or more LLRs in the third plurality of LLRs being the same as signs of one or more corresponding LLRs in the subset of the first plurality of LLRs; and
initiating the second decoding operation based at least in part on the first sign of the at least one LLR in the third plurality of LLRs being different from the second sign of the at least one corresponding LLR in the subset of the first plurality of LLRs.

21. The method of claim 11, wherein:
each of the subset of the plurality of information bits are decoded using the polar code with a respective subset of the plurality of bit-channels; and
each of the subset of the plurality of bit-channels are associated with a higher likelihood of error than a second subset of the plurality of bit-channels that is disjoint from the subset of the plurality of bit-channels.

22. The method of claim 11, further comprising:
receiving, after receiving the subset of the plurality of information bits and based at least in part on a second failure of the first wireless device to decode one or more information bits of the plurality of information bits, a second subset of the plurality of information bits corresponding to a respective third plurality of LLRs that are independent of the polar code, wherein a second index associated with each information bit in the second subset of the plurality of information bits is identified based at least in part on the order of the likelihood of error, the subset of the plurality of information bits, or a combination thereof.

23. An apparatus for wireless communication at a first wireless device, comprising:
a processor;
memory coupled with the processor; and
instructions stored in the memory and executable by the processor to cause the apparatus to:
transmit, via a channel between the first wireless device and a second wireless device, a codeword corresponding to a plurality of information bits encoded using a polar code; and
transmit, via the channel and independently of the polar code, a subset of the plurality of information bits based at least in part on identifying a failure of the second wireless device to decode one or more information bits of the plurality of information bits, wherein the subset of the plurality of information bits are selected according to an order of a likelihood of error associated with a plurality of bit-channels used for encoding the plurality of information bits according to the polar code.

24. The apparatus of claim 23, wherein the instructions are further executable by the processor to cause the apparatus to:
receive, from the second wireless device, signaling indicating the failure of the second wireless device to decode the one or more information bits, wherein identifying the failure is based at least in part on receiving the signaling.

25. The apparatus of claim 23, wherein identifying the failure is based at least in part on identifying that a capacity of the channel is less than a rate of the codeword transmitted over the channel.

26. The apparatus of claim 23, wherein the instructions are further executable by the processor to cause the apparatus to:
encode the subset of the plurality of information bits using a second code that is different from the polar code to generate a second codeword, wherein transmitting the subset of the plurality of information bits further comprises transmitting the second codeword.

27. An apparatus for wireless communication at a first wireless device, comprising:
a processor;
memory coupled with the processor; and
instructions stored in the memory and executable by the processor to cause the apparatus to:
receive, via a channel between the first wireless device and a second wireless device, a codeword corresponding to a plurality of information bits;
obtain a first plurality of log likelihood ratios (LLRs) associated with the plurality of information bits based at least in part on performing a first decoding operation on the codeword using a polar code;
receive, via the channel and based at least in part on a failure of the first wireless device to decode one or more information bits of the plurality of information bits, a second plurality of LLRs corresponding to a subset of the plurality of information bits, the second plurality of LLRs being received independent of the polar code, wherein an index associated with each information bit in the subset of the plurality of information bits is identified based at least in part on an order of a likelihood of error associated with a plurality of bit-channels used for decoding the codeword using the polar code; and
perform, on the codeword, a second decoding operation using the polar code and a combination of the first plurality of LLRs and the second plurality of LLRs.

28. The apparatus of claim 27, wherein the instructions are further executable by the processor to cause the apparatus to:
transmit, to the second wireless device, signaling indicating the failure of the first wireless device to decode the one or more information bits, wherein receiving the second plurality of LLRs is based at least in part on transmitting the signaling.

29. The apparatus of claim 27, wherein the instructions are further executable by the processor to cause the apparatus to:
transmit, to the second wireless device, signaling indicating a difference between a capacity of the channel and a rate of the codeword transmitted over the channel, wherein receiving the second plurality of LLRs is based at least in part on transmitting the signaling.

30. The apparatus of claim 27, wherein the instructions are further executable by the processor to cause the apparatus to:
transmit, to the second wireless device, signaling indicating an estimation of the channel, wherein receiving the second plurality of LLRs is based at least in part on transmitting the signaling.
